(19) United States
(12) Patent Application Publication
(10) Pub. No.: US 2016/0335375 A1
(43) Pub. Date: Nov. 17, 2016

(54) SUPPORT METHOD AND SUPPORT APPARATUS

(71) Applicant: FUJITSU LIMITED, Kawasaki-shi (JP)

(72) Inventor: Gentaro Hara, Nerima Ward (JP)

(21) Appl. No.: 15/151,044

(22) Filed: May 10, 2016

(30) Foreign Application Priority Data
May 11, 2015 (JP) 2015-096932

(51) Int. Cl. G06F 17/50

(52) U.S. Cl. CPC G06F 17/50

(57) ABSTRACT

According to a support method, a computer receives a selection of a first object from a combination of a plurality of objects. Then, the computer extracts an object in contact with the first object and an object in contact with the object in contact with the first object, among the plurality of objects. The computer determines that the extracted objects are target objects that move together with the first object.

### CROSS-REFERENCE TO RELATED APPLICATION(S)

This application is based upon and claims the benefit of priority of the prior Japanese Patent Application No. 2015-036932, filed on May 11, 2015, the entire contents of which are incorporated herein by reference.

### FIELD

The embodiments discussed herein are related to support methods and support apparatuses.

### BACKGROUND

In various machines, hardware is controlled by software. In developing such machines, the design of hardware involves the development of control software that controls the hardware. However, the development and verification of such control software after the completion of a real machine of the hardware leads to extending the development period of the machine.

Simulation tools that perform virtual simulations based on hardware design data are provided. In such simulation tools, for example, the development and verification of the control software is supported by using a virtual hardware model in which the objects of parts are arranged in a virtual space. Examples are described in, for example, Japanese Laid-open Patent Publication No. 2002-251419, Japanese Laid-open Patent Publication No. 2011-216024, Japanese Laid-open Patent Publication No. 2014-092905, Japanese Laid-open Patent Publication No. 05-253021, and Japanese Laid-open Patent Publication No. 2008-134943.

In conventional techniques, a user designates individual movable parts constituting a joint part from a virtual hardware model. Thus, for many movable parts, it takes time and labor to designate such parts, for example. Furthermore, for example, in developing control software, a software developer designates movable parts from a virtual hardware model. However, such a software developer may be unfamiliar with hardware, and thus it takes time and labor to designate the movable parts.

### SUMMARY

According to an aspect of an embodiment, a computer-readable recording medium has stored therein a program. The program causes a computer to execute a process including: receiving a selection of a first object from a combination of a plurality of objects; extracting an object in contact with the first object and an object in contact with the object in contact with the first object, among the plurality of objects; and determining that the extracted objects are target objects that move together with the first object.

According to another aspect of an embodiment, a computer executes a process by a support method. The process includes: receiving a selection of a first object from a combination of a plurality of objects; extracting an object in contact with the selected first object and an object in contact with the object in contact with the first object, among the plurality of objects; and determining that the extracted objects are target objects that move together with the first object.

According to still another aspect of an embodiment, a support apparatus includes a memory and a processor coupled to the memory. The processor performs a process to receive a selection of a first object from a combination of a plurality of objects. The processor further performs a process to extract an object in contact with the first object and an object in contact with the object in contact with the first object, among the plurality of objects. The processor performs a process to determine that the extracted objects are target objects that move together with the first object.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a schematic configuration of a support apparatus;

FIG. 2 is a diagram illustrating an example virtual hardware model based on parts stored in design data;

FIG. 3 is a diagram schematically illustrating an example assembly configuration of parts stored in the design data;

FIG. 4 is a diagram schematically illustrating an example assembly configuration of parts stored in joint part information;

FIG. 5 is a diagram illustrating an example designation of a driving part;

FIG. 6 is a diagram illustrating an example selection of a movable part;

FIG. 7 is a diagram illustrating an example switching between display and non-display of a part;

FIG. 8 is a diagram illustrating an example identification of a part having the same shape and the same attitude in a slide direction;

FIG. 9 is a diagram illustrating an example identification of a part having the same shape and the same attitude in a rotation-axis direction;

FIG. 10 is a diagram illustrating an example extraction of contacting parts;

FIG. 11 is a diagram illustrating an example extraction of a contacting part;

FIG. 12 is a diagram illustrating an example extraction of contacting parts;

FIG. 13 is a diagram illustrating an example extraction of fixed parts;

FIG. 14A is a diagram illustrating an example definition of selecting and driving a driving part;

FIG. 14B is a diagram illustrating an example designation of a part extraction range;

FIG. 14C is a diagram illustrating an example extraction of parts;

FIG. 14D is a diagram illustrating an example extraction of parts;

FIG. 14E is a diagram illustrating an example extraction of parts;

FIG. 14F is a diagram illustrating example display screens;

FIG. 14G is a diagram illustrating an example re-extraction result;

FIG. 14H is a diagram illustrating an example parts constituting a joint part;

FIG. 15A is a flowchart illustrating an example process of support processing;

FIG. 15B is a flowchart illustrating an example process of target-assembly determination processing;

FIG. 15C is a flowchart illustrating an example process of initial processing;

FIG. 15D is a flowchart illustrating an example process of part-information initialization processing;

FIG. 15E is a flowchart illustrating an example process of selected-joint-information initialization processing;

FIG. 15F is a flowchart illustrating an example process of fixed-part determination processing;

FIG. 15G is a flowchart illustrating an example process of fixed-part determination processing for sliding;

FIG. 15H is a flowchart illustrating an example process of fixed-part determination processing for rotation;

FIG. 15I is a flowchart illustrating an example process of extraction processing;

FIG. 15J is a flowchart illustrating an example process of route extension processing;

FIG. 15K is a flowchart illustrating an example process of route connection determination processing; and

FIG. 16 is a diagram illustrating a computer that executes a support program.

### DESCRIPTION OF EMBODIMENTS

Preferred embodiments of the present invention will be explained with reference to accompanying drawings. These embodiments may be combined within a range to keep the content of processing to be consistent.

[a] First Embodiment

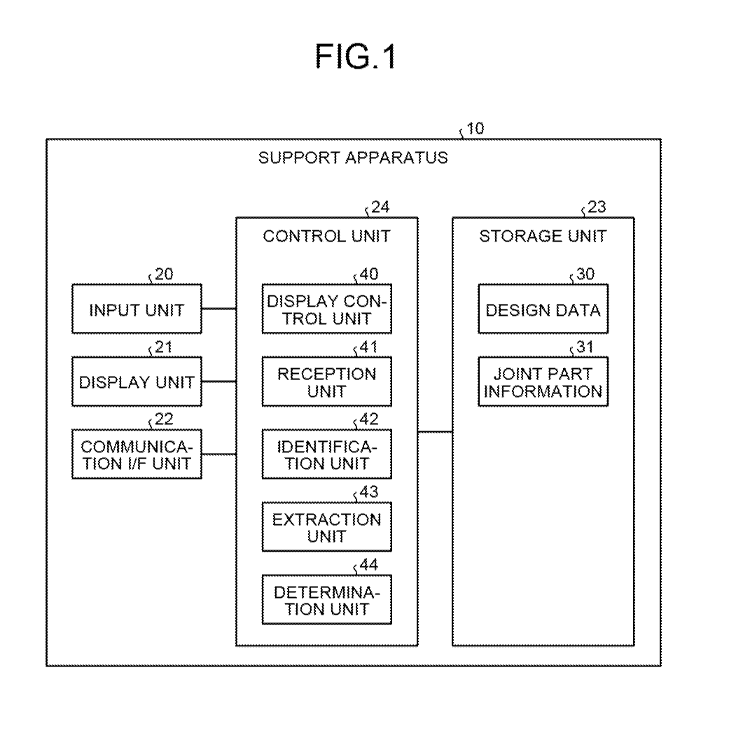

A support apparatus 10 according to a first embodiment will be described. FIG. 1 is a diagram illustrating a schematic configuration of the support apparatus 10. The support apparatus 10 is an apparatus that supports the development of machines. In the present embodiment, it will be described that, by way of an example, a virtual hardware model in which the objects of parts are arranged in a virtual space is generated and the development and verification of control software are supported, based on design data of the hardware of a machine. The support apparatus 10 may be used for supporting the production of machines. For example, the support apparatus 10 may be used for designating movable parts in preparing documents used for the production of machines.

For example, the support apparatus 10 is a computer, such as a personal computer and a server computer. The support apparatus 10 may he implemented as a single computer or may be implemented as a cloud of a plurality of computers. In the present embodiment it will be described that, by way of example, the support apparatus 10 is a single computer. For example, the support apparatus 10 is

a computer used by a developer who develops control software that controls the hardware of a machine under development. The support apparatus 10 may be a design apparatus on which design software for designing hardware is executed. Such a design apparatus includes a computer aided design (CAD) apparatus. As illustrated in FIG. 1, the support apparatus 10 includes an input unit 20, a display unit 21, a communication interface (I/F) unit 22, a storage unit 23, and a control unit 24.

The input unit 20 is an input device that receives inputs of various types of information. The input unit 20 includes an input device that receives operation inputs of a mouse, a keyboard, and other device. The input unit 20 receives inputs of various types of information. For example, the input unit 20 receives various types of operation inputs to a virtual hardware model. The input unit 20 receives an operation input from a user and inputs operation information indicating the content of the received operation to the control unit 24.

The display unit 21 is a device that displays various types of information. The display unit 21 includes a display device, such as a liquid crystal display (LCD) and a cathode ray tube (CRT). The display unit 21 displays various types of information. For example, the display unit 21 displays various types of screens, such as a screen of a virtual hardware model (discussed below) in which the objects of parts are arranged in a three-dimensional virtual space and an operation screen.

The communication I/F unit 22 is an interface that performs communication control between other apparatuses. The communication I/F unit 22 transmits and receives various types of information to or from other apparatuses through a network (not illustrated). For example, the communication I/F unit 22 receives design data 30 described below from other apparatuses. For example, as design data 30, the communication I/F unit 22 receives CAD data in which hardware is designed, from a CAD apparatus for designing the hardware of a machine. The communication I/F unit 22 can includes a network interface card, such as a LAN card. The support apparatus 10 may obtain information including the design data 30 via a storage medium, such as a memory card. The design data 30 may be input from the input unit 20.

The storage unit 23 is a storage device, such as a hard disk, a solid state drive (SSD), and an optical disk. The storage unit 23 may be a data-rewritable semiconductor memory, such as a random access memory (RAM), a flash memory, and a non volatile static random access memory (NVSRAM).

The storage unit 23 stores various types of programs and an operating system (OS) executed on the control unit 24. The storage unit 23 stores, for example,

a program for executing various types of processing related to generating and operating a virtual hardware model discussed below. Furthermore, the storage unit 23 stores various types of data used for programs executed on the control unit 24. The storage unit 23 stores, for example, the design data 30 and joint part information 31.

The design data 30 is data in which the hardware of a machine is designed with a three-dimensional CAD. The design data 30 stores part design information for each part constituting the machine. For example, as the design information, the design data 30 stores, the shapes, positions, and attitudes of the parts constituting the machine, and other information. For example, the design data 30 stores part origin coordinates, a part local coordinate system, and part shape information, for each part constituting a machine. The part origin coordinates is information indicating coordinates used as the origin point of position information related to a part in the coordinates of a three-dimensional virtual space. The part origin coordinates may be different for different parts, or the common origin point may be used for each part. The part local coordinate system is information indicating, for each part, a coordinate system used for defining the position of a part in a three-dimensional virtual space with reference to the origin coordinates of the part. The part local coordinate system may be different for different parts, or the common coordinate system may be used for each part. The shape information is information indicating, for each part, the shape of a part in the local coordinate system of the part with reference to the origin coordinates of the part. For example, when the shape of a part is stored with a combination of triangles, the shape information stores the vertex coordinates of each triangle forming the shape of the part and the normal vector of the surface of each triangle. The support apparatus 10 generates a virtual hardware model from the shapes of the parts constituting a machine. Thus, it is only needed that the design data 30 stores the shapes of the parts constituting the machine, the positions and attitudes of parts, and other information. Furthermore, the design data 30 may store assembly-classified parts. The classification of parts into assemblies depends on a hardware designer. For example, the designer may classify parts into the same assembly in units of functions or in units of the same parts, to help determining parts, for example, in units of movable joint parts in the machine. In the present embodiment, the parts constituting the machine in the design data 30 are classified into assemblies in units of functions, such as parts that configure a carrying function.

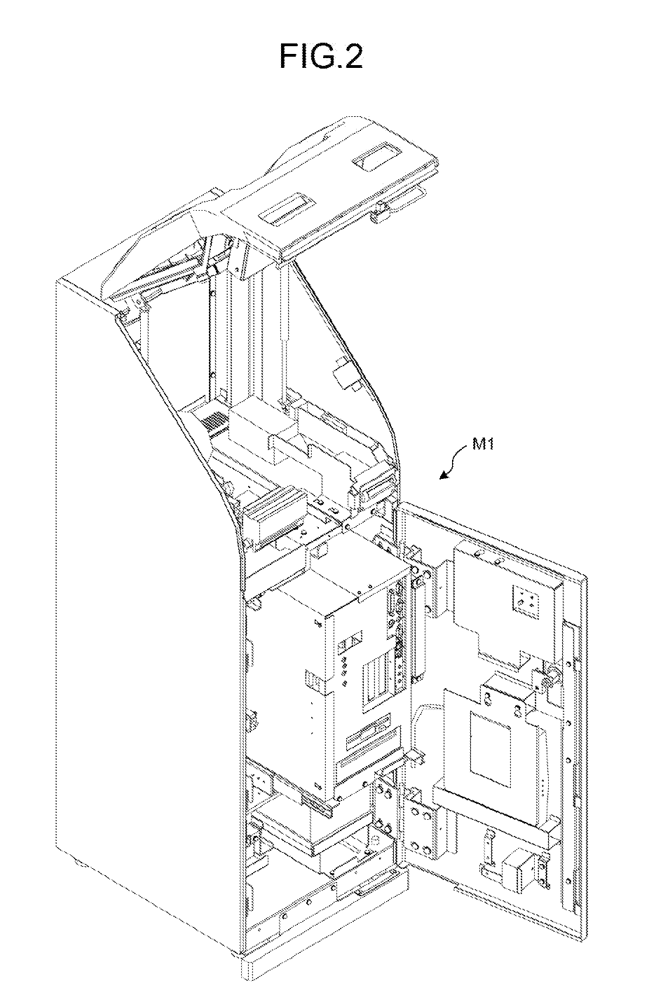

FIG. 2 is a diagram illustrating an example virtual hardware model based on parts stored in the design data. For example, FIG. 2 is a machine that mechanizes various works and processes in factories for factory automation (FA). As illustrated in FIG. 2, the machine is constituted of many parts.

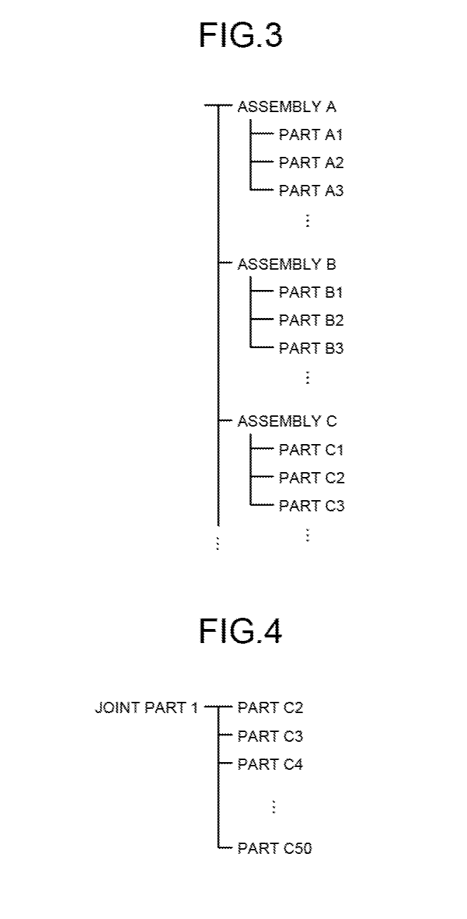

FIG. 3 a diagram schematically illustrating an example assembly configuration of parts stored in the design data. The design data 30 registers assembly-classified parts for each assembly. For example, parts A1, A2, A3, . . . constitute an assembly A. Parts B1, B2, B3, . . . constitute an assembly B. Parts C1, C2, C3, . . . constitute an assembly C.

The joint part information 31 is data that stores information related to joint parts capable of actions, such as movement. For example, the joint part information 31 is data that stores parts for which it is determined that they move with a designated part.

FIG. 4 is a diagram schematically illustrating an example assembly configuration of parts stored in the joint part information. The joint part information 31 registers parts for which it is determined that they are movable parts. For example, parts C2, C3, C4, . . . , C50 are registered at a joint part 1.

Returning to FIG. 1, the control unit 24 is a device that controls the support apparatus 10. The control unit 24 can include an electronic circuit, such as a central processing unit (CPU) and a micro processing unit (MPU), and an integrated circuit, such as an application specific integrated circuit (ASIC) and a field programmable gate array (FPGA). The control unit 24 includes an internal memory for storing programs that define various types of processes and control data, and performs various processing with such programs and data. The control unit 24 functions as various types of processing units when various types of programs are executed. For example, the control unit 24 includes a display control unit 40, a reception unit 41, an identification unit 42, an extraction unit 43, and a determination unit 44.

The display control unit 40 controls displaying various types of information on the display unit 21. For example, the display control unit 40 controls displaying a virtual hardware model in which the objects of parts are arranged in a virtual space, based on the design data 30. For example, the display control unit 40 displays a virtual hardware model in which the object of the outline shape of each part is arranged, using information including the shapes of parts and the positions and attitudes of parts stored in the design data 30. For example, the display control unit 40 controls displaying various types of operation screens for operating the virtual hardware model.

The reception unit 41 receives various types of operations of the virtual hardware model from the input unit 20. For example, the reception unit 41 receives operations, such as zooming in or out of the displayed hardware model and a change of the display position of the hardware model. The display control unit 40 changes the display of the hardware model in response to the received operation. Furthermore, the reception unit 41 receives the selection of an operable driving part from the objects of a plurality of parts constituting the hardware model. Furthermore, the reception unit 41 receives the designation of the definition of driving a driving part. For example, the reception unit 41 receives the designation of a driving class about how to drive a driving part, such as rotation and sliding, and the designation of its driving direction. For example, when the driving part is a rotating part, the reception unit 41 receives the designation of a driving class indicating that the driving part is a rotating part and the designation of a rotation axis and a rotation direction of the driving part. Furthermore, for example, when the driving part is a sliding part, the reception unit 41 receives the designation of a driving class indicating that the driving part is a sliding part and the designation of a movement direction of the driving part.

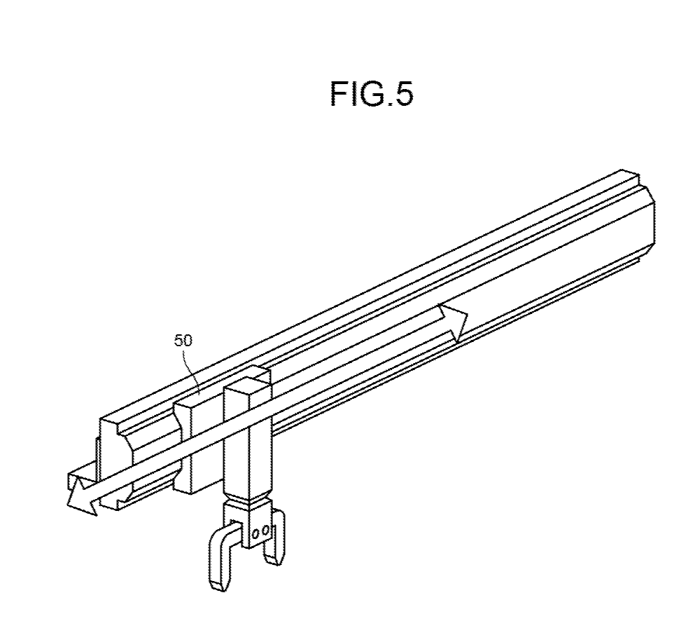

FIG. 5 is a diagram illustrating an example designation of a driving part. FIG. 5 illustrates parts constituting a joint part capable of sliding along a rail. In the example of FIG. 5, the driving class indicating that a part 50 is a sliding driving part is designated, and a movement direction along a rail direction is designated, as indicated by an arrow.

Such an operable driving part may be designated in advance. For example, a hardware designer may register the definition of driving a driving part from a CAD apparatus in designing hardware, and the design data 30 may store definition information of driving the driving part. Furthermore, a driving part is not always designated. That is, the designation of a driving part is not always needed.

Furthermore, the reception unit 41 receives the selection of a movable part. For example, the reception unit 41 receives the selection of the object of a movable part from, the hardware model. Furthermore, the reception unit 41 receives the designation of a part extraction range. For example, the reception unit 41 receives the designation of an extraction range for each part assembly stored in the design data 30. Furthermore, for example, the reception unit 41 receives the selection of a non-movable part. For example, the reception unit 41 receives the selection of the object of a non-movable part from the hardware model.

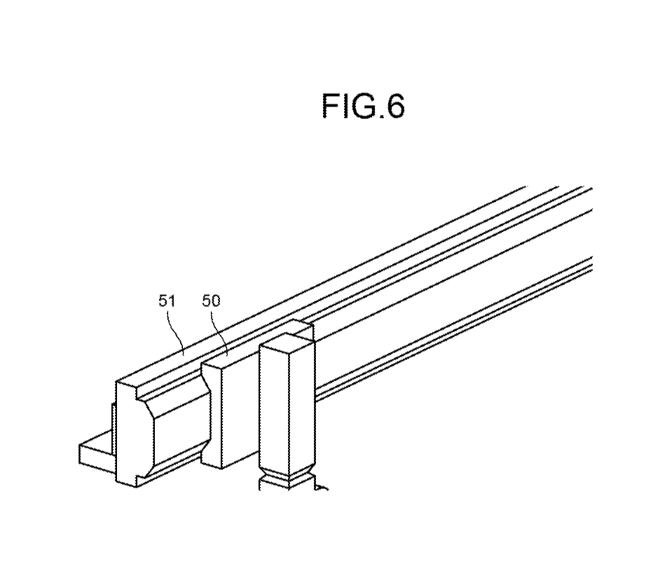

FIG. 6 is a diagram illustrating an example selection of a movable part. As in FIG. 5, FIG. 6 illustrates the parts constituting the joint part capable of sliding along a rail. The example of FIG. 6 illustrates that the part 50 is selected as a movable part and a part 51 constituting the rail is selected as a non-movable part.

Furthermore, the reception unit 41 receives a switching operation between display and non-display of a part for each part of the displayed hardware model. The display control unit 40 changes the display or non-display for each part of the hardware model in response to the received switching operation.

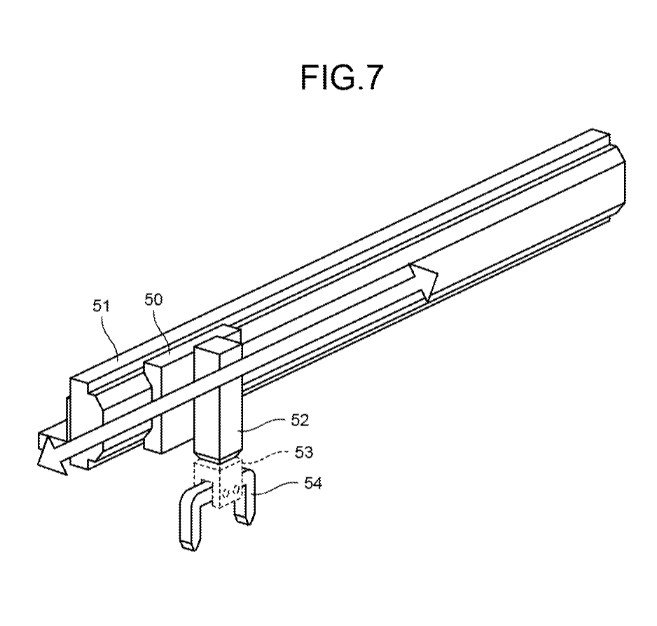

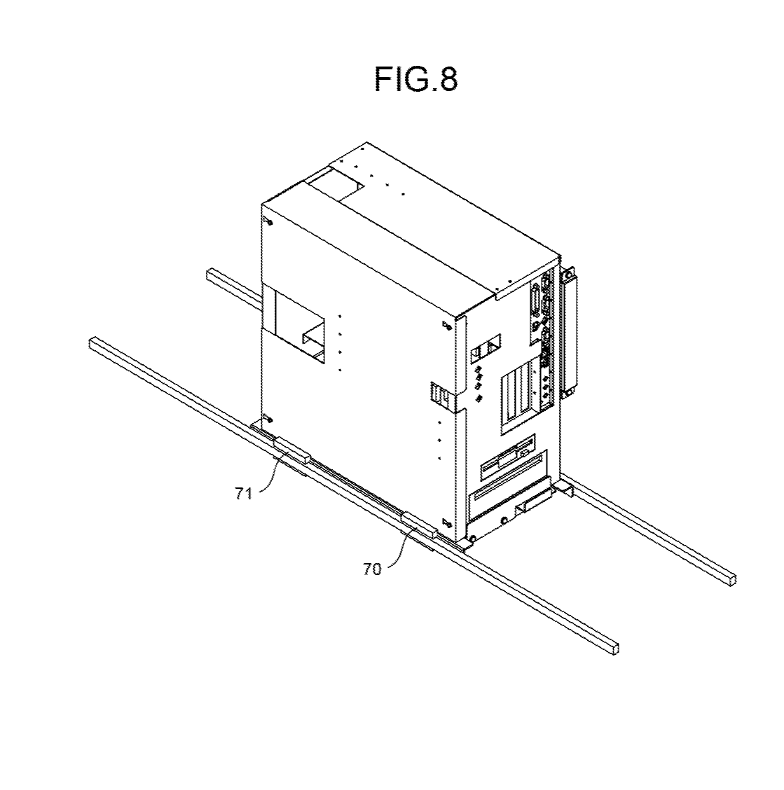

FIG. 7 is a diagram illustrating an example switching between the display and non-display of a part. As in FIG. 5, FIG. 7 illustrates the parts constituting the joint part capable of sliding along the rail. The example of FIG. 7 illustrates the following case: the part 50 is in contact with a part 52; the part 52 is in contact with a part 53; the part 53 is in contact with a part 54; and the part 53 is switched to non-display. In the example of FIG. 7, the part 53, which is non-display, is indicated by dotted lines.

The identification unit 42 performs various types of identification. For example, the identification unit 42 identifies a part having the same shape and the same attitude from the plurality of parts of the hardware model, based on the design data 30. For example, when the reception unit 41 receives the selection of a movable part, the identification unit 42 identifies a part having the same shape and the same attitude as the movable part from a plurality of parts of the hardware model, based on the design data 30. For example, the identification unit 42 retrieves the same shape and the same attitude as the movable part from the parts of the hardware model, based on the design data 30. For example, when translating the movable part, the identification unit 42 identifies a part matching the movable part as a part having the same shape and the same attitude. Furthermore, for example, when the reception unit 41 receives the selection of a non-movable part, the identification unit 42 identifies a part having the same shape and the same attitude as the non-movable part from the plurality of parts of the hardware model, based on the design data 30. Furthermore, for example, when the extraction unit 43 described below determines a fixed part, the identification unit 42 identifies a part having the same shape and the same attitude as the fixed part from the plurality of parts of the hardware model, based on the design data 30. Furthermore, for example, when a driving part designated to slide is selected as a movable part, the identification unit 42 identifies a part placed along a sliding direction of the driving part and having the same shape and the same attitude. For example, when translating the driving part along its sliding direction, the identification unit 42 identifies a part matching the driving part as a part having the same shape and the same attitude. Furthermore, for example, when a driving part designated to rotate is selected as a movable part, the identification unit 42 identifies a part placed along a rotation-axis direction of the driving part and having the same shape and the same attitude. For example, when translating the driving part along its rotation axis, the identification unit 42 identifies a part matching the driving part as a fixed part having the same shape and the same attitude. When part design information has information indicating the rotation state of a part, the identification unit 42 may identify a part also matching the rotation state as a part having the same shape and the same attitude.

FIG. 8 is a diagram illustrating an example

identification of a part having the same shape and the same attitude in a sliding direction. FIG. 8 illustrates a joint part capable of sliding on two rails, and a part 70 in contact with one rail is designated as a driving part capable of sliding along these rails. In the example of FIG. 8, when the part 70 is selected as a movable part, a part 71 having the same shape and the same attitude as the part 70 is identified. Although hidden in FIG. 8, a part slidably attached to the other rail and having the same shape and the same attitude as the part 70 is also identified.

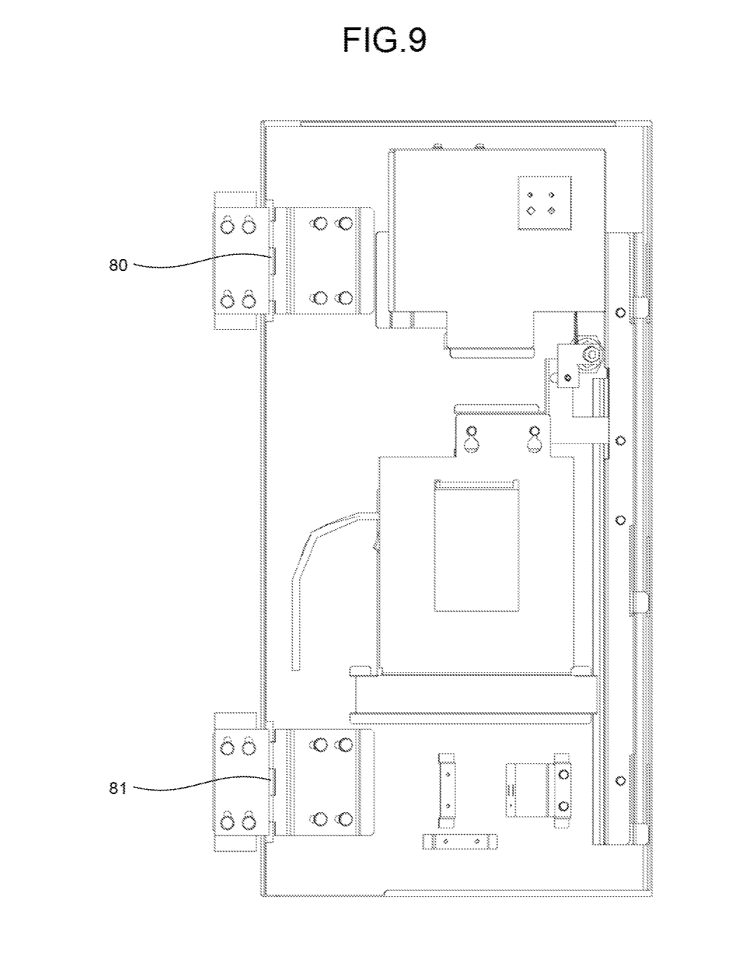

FIG. 9 is a diagram illustrating an example identification of a part having the same shape and the same attitude in a rotation-axis direction. FIG. 9 illustrates that an openable and closable door is a joint part, and a part 80 supporting the door is designated as a driving part designated to rotate about its rotation axis in the vertical direction. In the example of FIG. 9, when the part 80 is selected as a movable part, a part 81 placed along the rotation-axis direction of the part 80 and having the same shape and the same attitude as the part 80 is identified.

The extraction unit 43 extracts a movable joint part. For example, the extraction unit 43 sequentially extracts a part in contact with the movable part selected by the reception unit 41, a contacting part in contact with the contacting part, and so on. That is, the extraction unit 43 sequentially extracts parts in contact relation from the selected movable part, among the plurality of parts constituting the hardware model. For example, the extraction unit 43 regards the selected movable part as a determination target part, and identifies a surrounding part of the determination target part based on the design data 30. The extraction unit 43 then determines whether the surrounding part is in contact with the determination target part for each identified surrounding part, based on the design data 30. For example, the extraction unit 43 determines individual outline polygons of the determination target part and the surrounding part, based on the design data 30. The extraction unit 43 determines whether the polygons of the determination target part and the surrounding part have the same coordinates. When these outlines have the same coordinates, the extraction unit 43 determines that the determination target part is in contact with the surrounding part and extracts the contacting part. If there is any contacting part, the extraction unit 43 regards the contacting part as a determination target part and further extracts a part in contact with the determination target part. With this, the objects of parts in contact relation from the movable part are extracted from the hardware model. Furthermore, when a non-movable part is selected, the extraction unit 43 targets parts other than the non-movable part to extract parts in contact relation. That is, the extraction unit 43 extracts parts having contact relation, without regarding the non-movable part as a determination target part. For example, when surrounding parts of a determination target part includes a non-movable part, the extraction unit 43 determines whether surrounding parts other than the non-movable part are in contact relation with the determination target part.

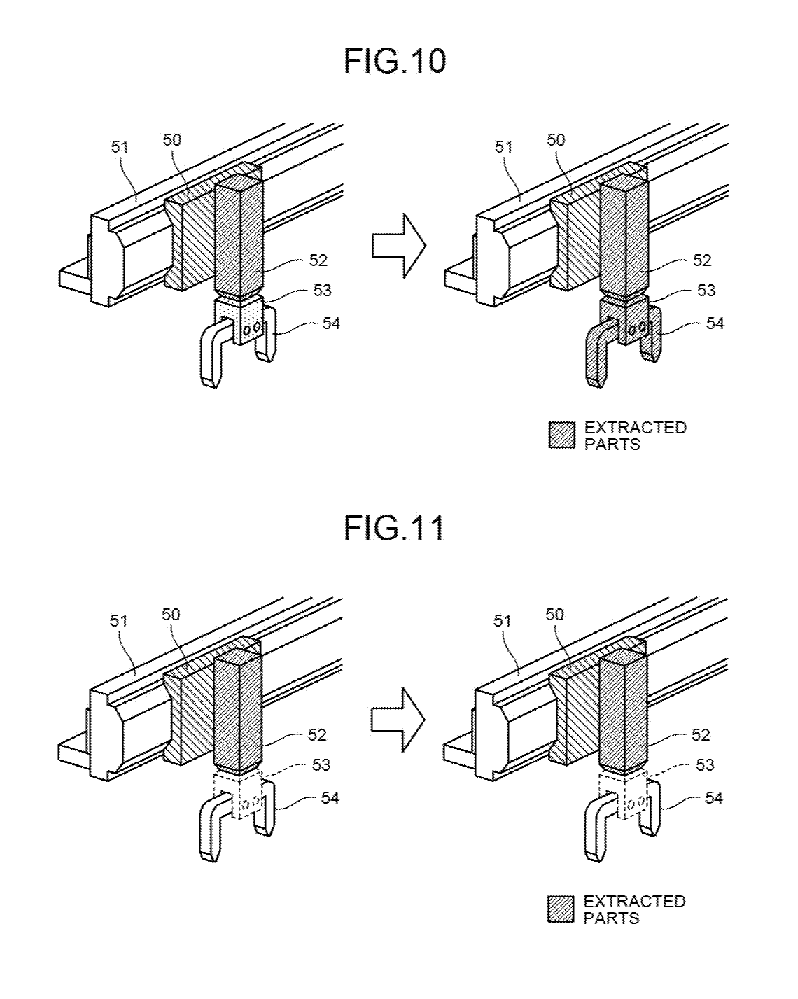

FIG. 10 is a diagram illustrating an example extraction of contacting parts. As in FIG. 5, FIG. 10 illustrates the parts constituting the joint part capable of sliding along the rail. In the parts constituting the joint part, illustrated in FIG. 10, adjacent parts are mutually in contact. The example of FIG. 10 illustrates that the part 50 is selected as a movable part and the part 51 constituting the rail is selected as a non-movable part. In this case, the parts other than the part 51 of the rail, which constitute the joint part, are extracted. In the example of FIG. 10, the part 50 is in contact with the part 52, the part 52 is in contact with the part 53, and the part 53 is in contact with the part 54. Thus, the parts 52 to 54 are extracted.

The present embodiment is capable of switching between display and non-display for each part, and thus extracting parts in contact relation for a non-display part may lead to a mismatch between its display state and the contact relation. To avoid this, the extraction unit 43 extracts parts in contact relation for displayed parts.

FIG. 11 is a diagram illustrating an example extraction of a contacting part. As in FIG. 7, FIG. 11 illustrates that the part 53 is switched to non-display. The example of FIG. 11 also illustrates that the part 50 is selected as a movable part and the part 51 constituting the rail is selected as a non-movable part. In this case, the part 53 is non-display and thus the part 52 is extracted. In contrast, the part 54 is not extracted.

When the identification unit 42 identifies a part having the same shape and the same attitude as the movable part, the extraction unit 43 regards the identified part as a determination target for contact relation and extracts parts in contact relation. With this, if there are a plurality of non-movable parts having the same shape and the same attitude and one of them is selected, the objects of parts in contact relation from the non-movable part are extracted from the hardware model, except for the plurality of non-movable parts.

When parts in contact relation have been sequentially extracted, for example, all the parts of the hardware model may be extracted. Typically, to stabilize behavior of a joint part, such as vibration with its movement, a movable joint part is placed on a fixed part supporting or securing the joint part. Such a fixed part supporting a joint part is typically large in relation to the joint part. Thus, the extraction unit 43 determines a fixed part. The extraction unit 43 then sequentially extracts parts in contact relation, except for the fixed part.

For example, when a joint part slides, the joint part is supported by a fixed part, such as a rail supporting sliding movement of the joint part. When a part designated to slide is selected as a movable part, for each determination target part, the extraction unit 43 determines the length of its surrounding part in the sliding direction. In the present embodiment, the extraction unit 43 determines the length of a part in direct contact with the selected movable part in the sliding direction. The extraction unit 43 then regards a part the length of which in the sliding direction is equal to or larger than a predetermined multiple of the length of the movable part in the sliding direction as a fixed part, and for surrounding parts other than the fixed part, determines that the determination target part is in contact with its surrounding parts. For example, the predetermined multiple is 10. The predetermined multiple may be configurable from the outside. For example, a user may designate it via a screen. This configuration prevents a fixed part, such as a rail supporting sliding movement of a joint part, from being extracted, for example.

Furthermore, for example, when a joint part rotates, the joint part is rotatably supported by a large fixed part not passing through the rotation axis of the joint part. When a part designated to rotate is selected as a movable part, the extraction unit 43 determines a part not passing through the rotation axis of the movable part, among parts in contact with the movable part. The extraction unit 43 then determines that the largest part of the parts not passing through the rotation axis of the movable part is a fixed part. This configuration prevents a fixed part supporting rotating movement of the joint part from being extracted, for example.

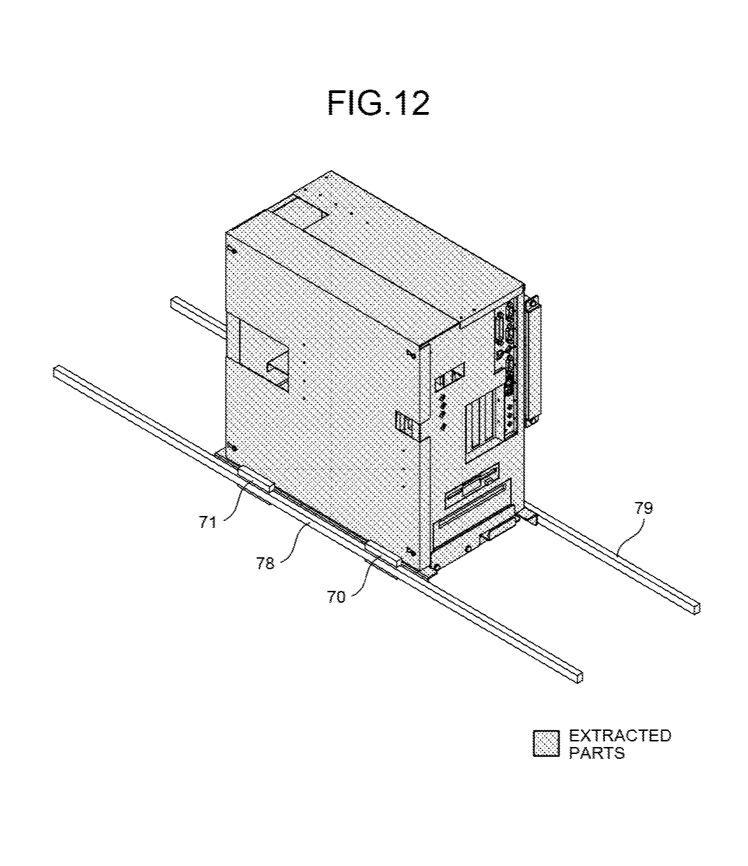

FIG. 12 is a diagram illustrating an example extraction of contacting parts. As in FIG. 8, FIG. 12 illustrates the joint part capable of sliding on the two rails, and the part 70 in contact with one rail is designated as a driving part capable of sliding along the rails. In the parts constituting the joint part, illustrated in FIG. 12, adjacent parts are mutually in contact. The example of FIG. 12 illustrates that the part 70 is selected as a movable part. A part 78 constituting the rail, the length of which in the sliding direction of the part 70 is equal to or larger than a predetermined multiple of the length of the part 70 in the sliding direction, is regarded as a fixed part and is excluded from determination targets for contact relation. The identification unit 42 identifies a part 79 constituting the rail as a fixed part having the same shape and the same attitude as the part 78, and the part 79 is excluded from the determination targets for contact relation. Thus, in the example of FIG. 12, the parts that are in contact relation from each of the part 70 and the part 71 having the same shape and the same attitude as the part 70 are extracted, and the parts with a dotted pattern, including the parts 70 and 71, are extracted.

Furthermore, when the identification unit 42 identifies a plurality of parts having the same shape and the same attitude as the movable part along its sliding direction, the extraction unit 43 determines the length, in the sliding direction, of the portion on which the identified plurality of parts are placed. That is, the extraction unit 43 determines the length of the plurality of parts in the sliding direction, including portions among the parts. The extraction unit 43 then regards a part the length of which in the sliding direction is equal to or larger than a predetermined multiple of the length of the movable part in the sliding direction as a fixed part, and for parts other than the fixed part, determines that the determination target part is in contact with its surrounding parts. For example, the predetermined multiple is 10. The predetermined multiple may be configurable from the outside. For example, a user may designate it via a screen. This configuration prevents fixed parts, such as conveying rollers of a belt conveyor, from being extracted, for example.

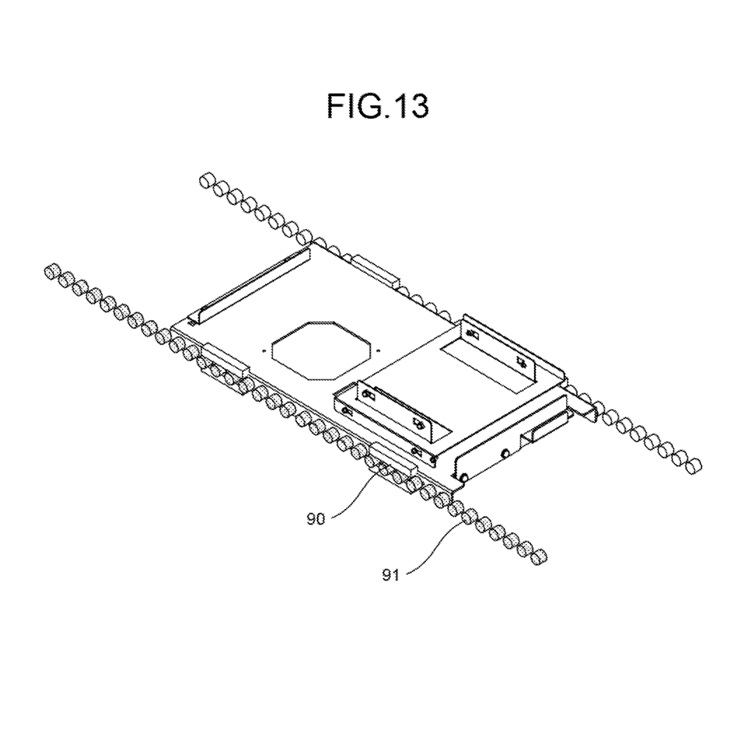

FIG. 13 is a diagram illustrating an example extraction of fixed parts. In FIG. 13, a part 91 constituting a plurality of conveying rollers of, for example, a belt conveyor is placed. The example of FIG. 13 illustrates the following case: a part 90 is designated as a driving part that slides in a arranged direction of the conveying rollers; and the length, in the sliding direction, of the part 90 constituting the conveying rollers is equal to or larger than a predetermined multiple of the length of the part 91 in the sliding direction. In this case, the part 91 constituting the conveying rollers is regarded as a fixed part and is excluded from determination targets for contact relation.

Furthermore, machines use a large part as a base part. Such a base part serves as a non-moving fixed part. The extraction unit 43 defines a threshold of the volume of a base part based on the total volume of a machine and determines a part having a volume equal to or larger than the threshold is a fixed part. For example, the extraction unit 43 adds the volumes of parts in the descending order of their volumes, and identifies a part having an added volume that is a predetermined percentage of the volume of all the parts. For example, the predetermined percentage is 30%. The predetermined percentage may be configurable from the outside. For example, a user may designate it via a screen. The extraction unit 43 regards the volume of the identified part as a threshold of a fixed part and determines a fixed part serving as a base.

Furthermore, a joint part of a machine may be supported by a fixed part having a shape covering the joint part, to stabilise the joint part. When a contacting part is a part that has a shape covering an extracted group of parts, the extraction unit 43 determines the part as a fixed part. For example, when a part designated to slide is selected as a movable part, the extraction unit 43 determines a section of a hardware model in a vertical direction to the sliding direction within an arranged range of contacting parts. When a part in contact within arranged range of contacting parts covers the three surfaces or more of the extracted group of parts, the extraction unit 43 determines the contacting part as a fixed part. Furthermore, for example, upon a part designated to rotate being selected as a movable part, if a contacting part covers both ends of the extracted group of parts in their rotation-axis direction, the extraction unit 43 determines that the contacting part is a fixed part.

Furthermore, when the total volume of the extracted parts reaches a volume having a predetermined percentage or more to the total volume of all the parts of the hardware model, the extraction unit 43 terminates the extraction of parts. For example, the predetermined percentage is 50%. The predetermined percentage may be configurable from the outside. For example, a user may designate it via a screen. This configuration prevents all the parts of the hardware model from being extracted, for example.

The determination unit 44 determines the parts constituting a movable joint part. For example, the determination unit 44 regards parts extracted by the extraction unit 43 as parts that move together with a movable part to determine the parts constituting the movable joint part. The determination unit 44 stores the movable part and the extracted parts in the joint part information 31 in association with each other.

The following description will be made using a specific example. Hereinafter, by way of an example, it will be described that the designation of a movable part for the hardware model illustrated in FIG. 2 is supported.

The display control unit 40 displays a virtual hardware model in which the object of the outline shape of each part is arranged, using information including the shapes of parts and the positions and attitudes of parts stored in the design data 30. The reception unit 41 receives various types of operations of the virtual hardware model from the input unit 20. For example, the reception unit 41 receives operations, such as zooming in or out of the displayed hardware model and a change of the display position of the hardware model.

A control-software developer operates the input unit 20 to issue various types of instructions, such as zooming in or out of the displayed hardware model and a change of the display position of the hardware model. Further the control-software developer operates the input unit 20 to select an operable driving part and perform the definition of driving the selected driving part.

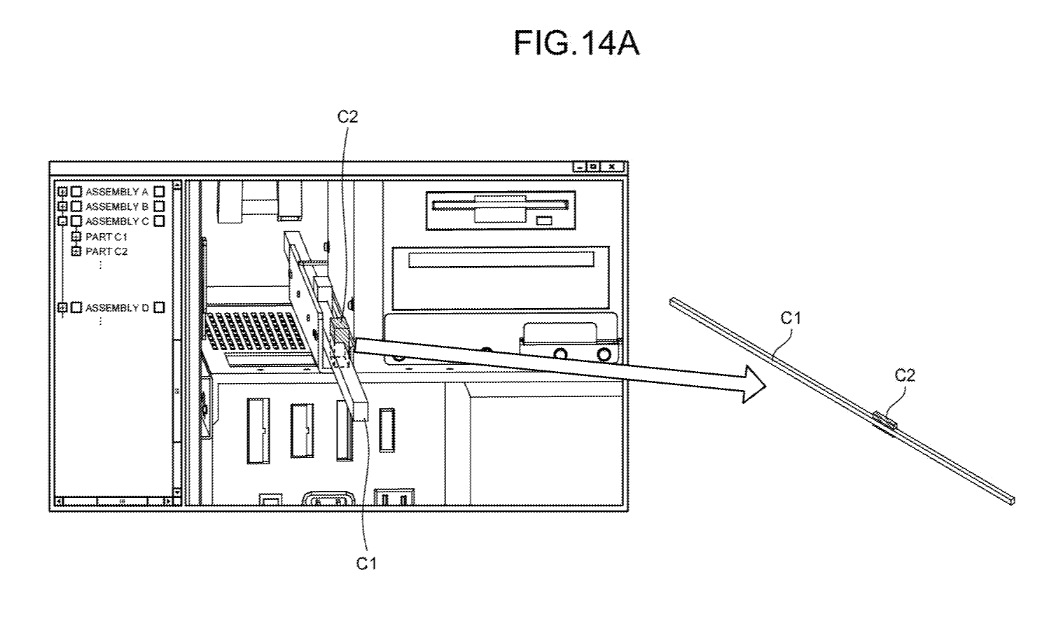

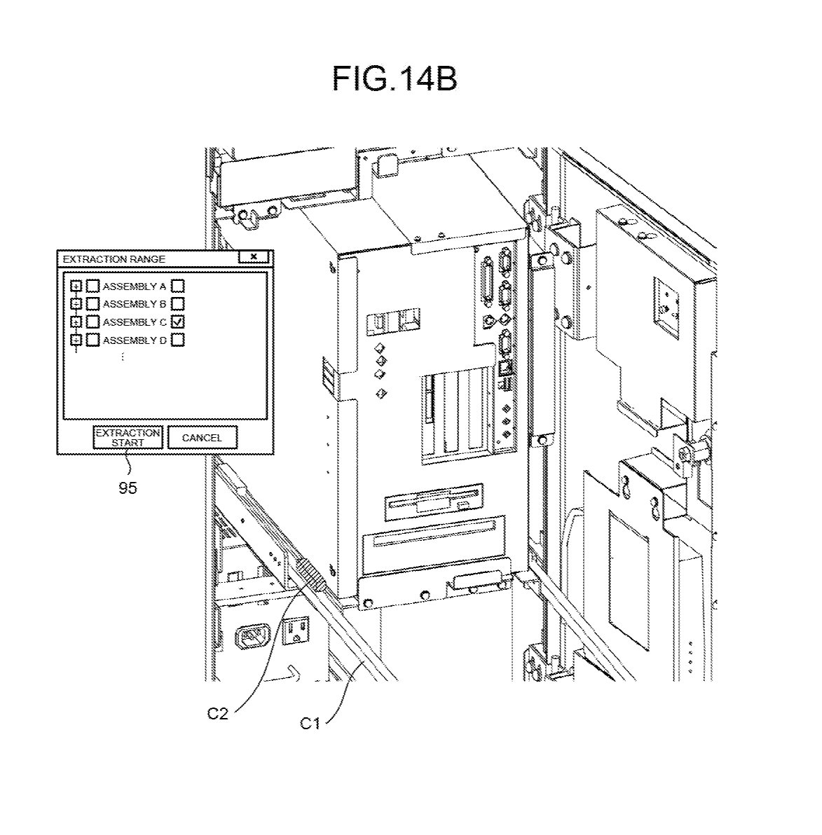

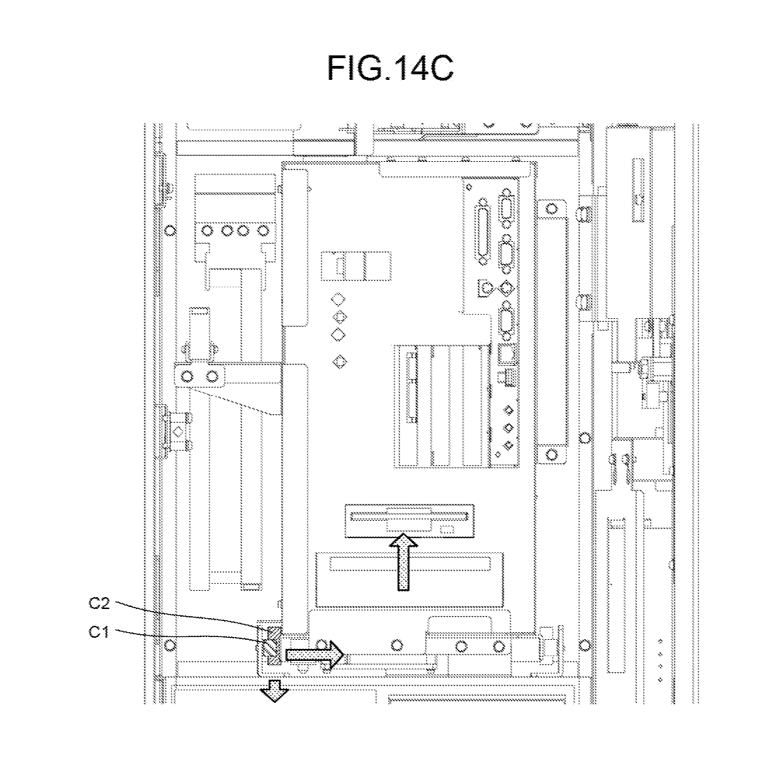

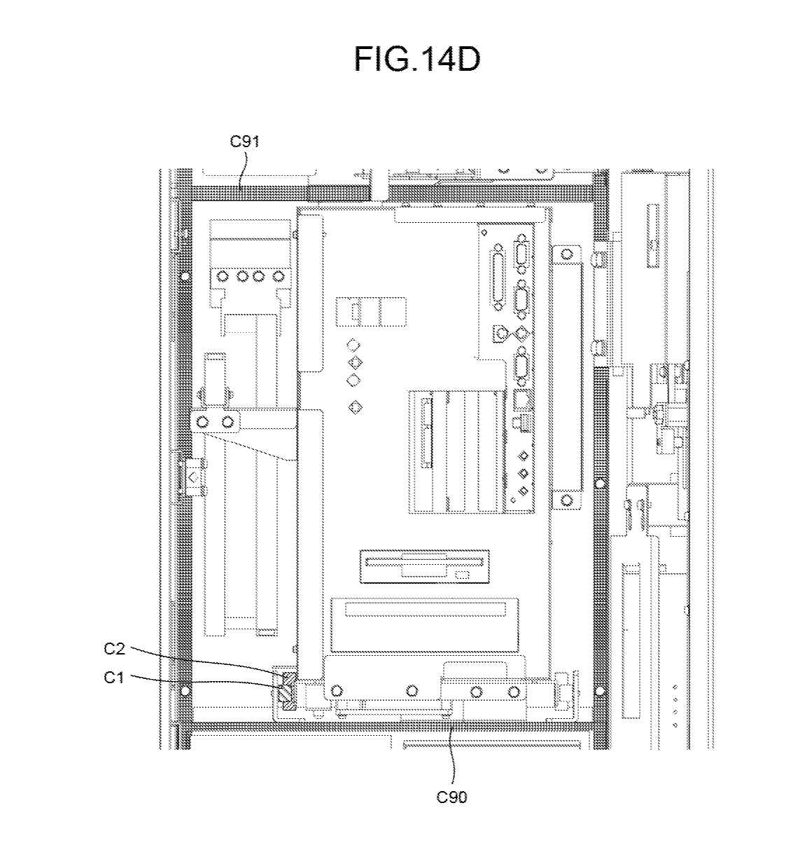

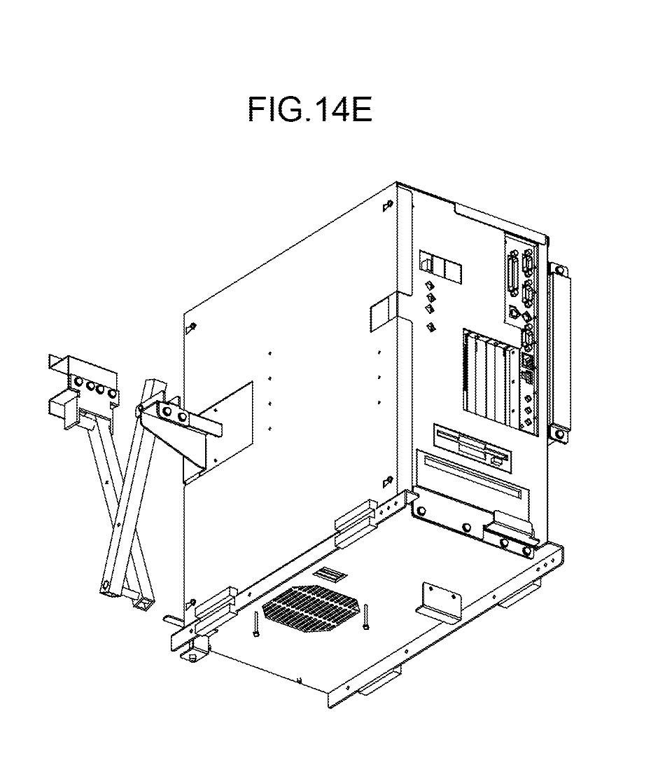

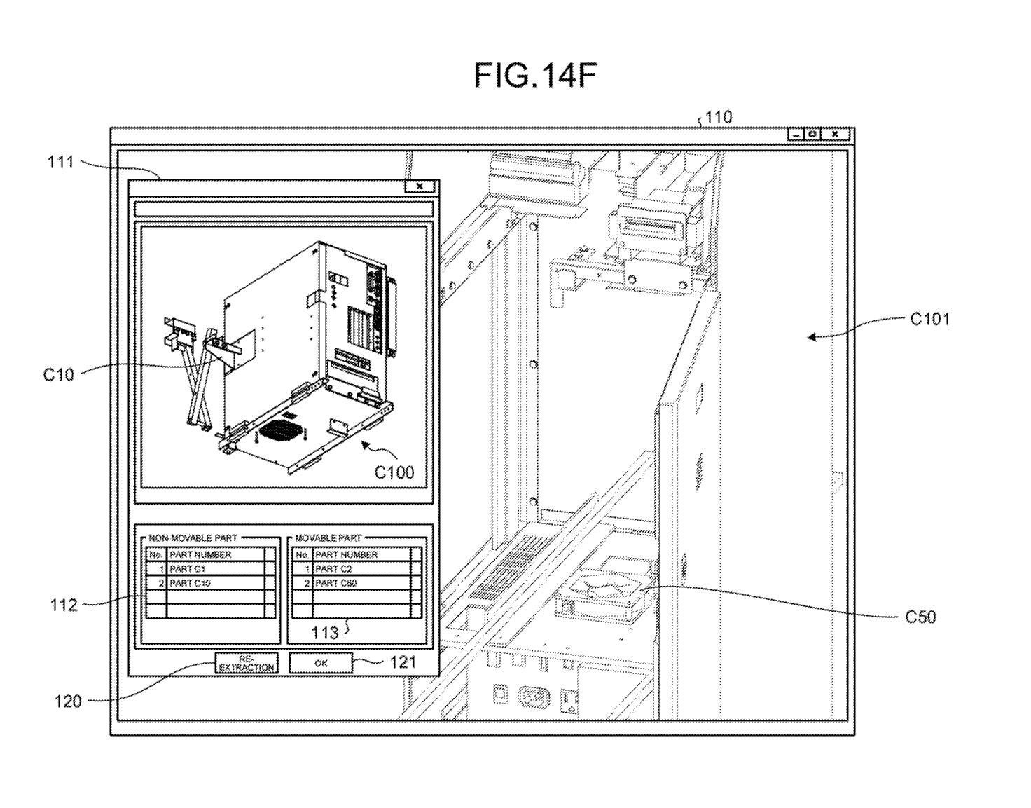

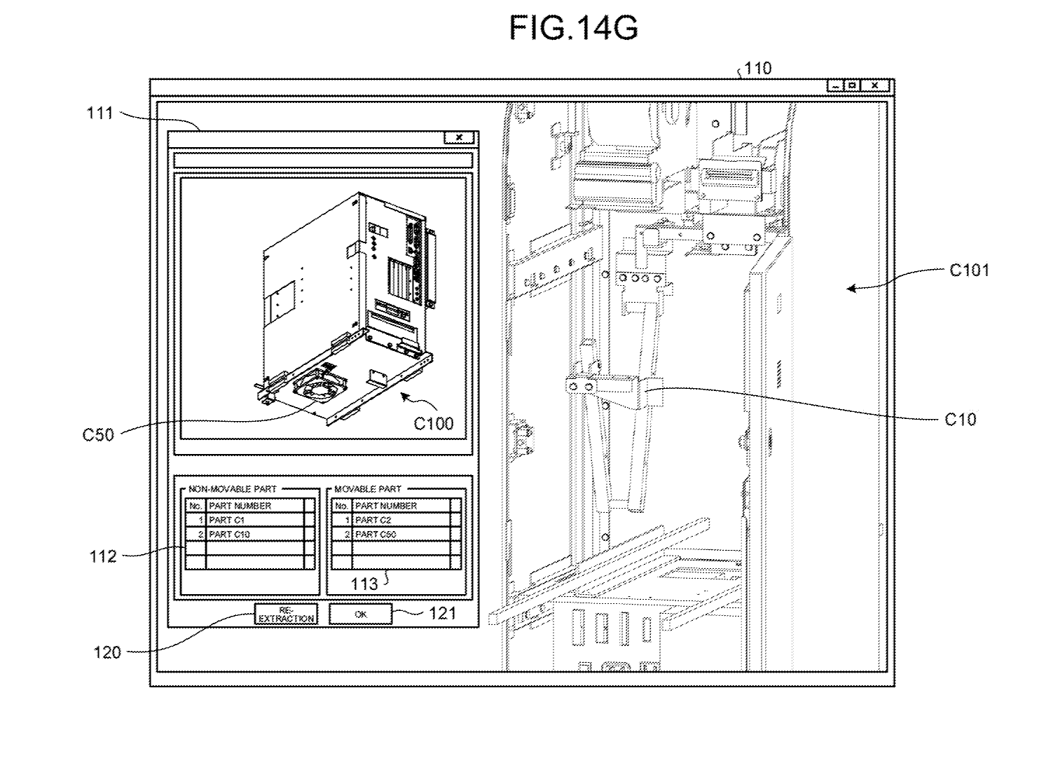

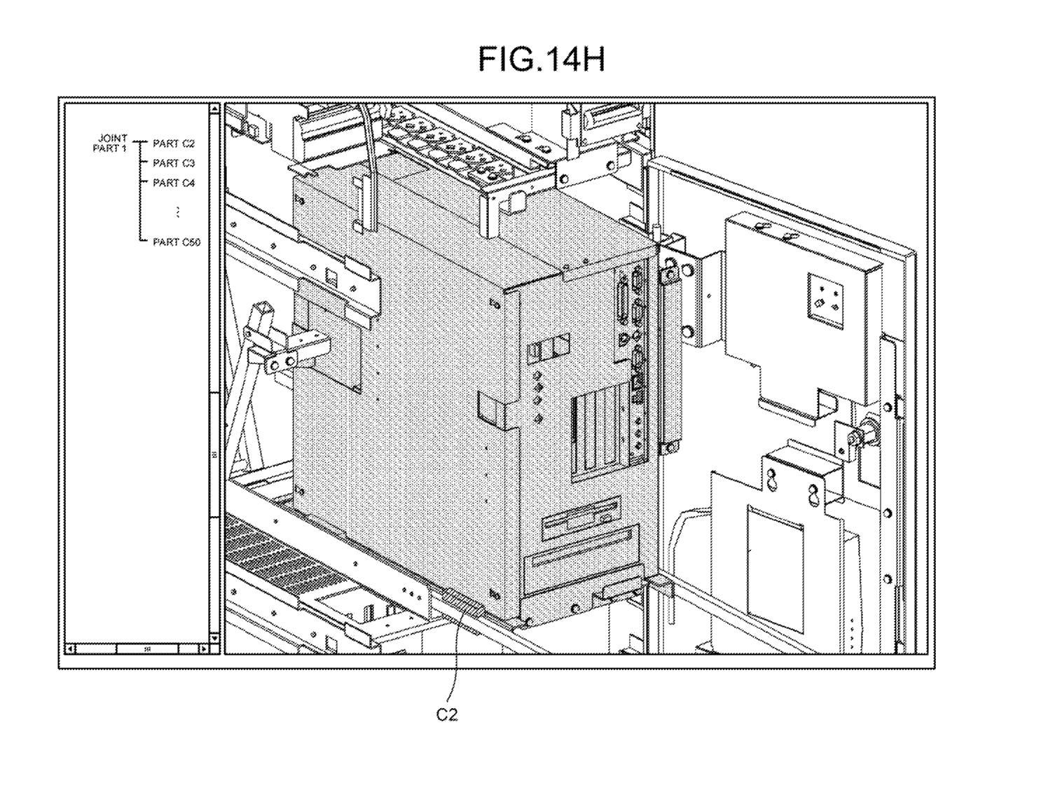

FIG. 14A is a diagram illustrating an example definition of selecting and driving a driving part. FIG. 14A illustrates that the MI portion of the hardware model illustrated in FIG. 2 is enlarged for display with a visual-line direction changed. The example of FIG. 14A illustrates that the part C2 placed on the longer part C1 is selected and the longitudinal direction of the part C1 is designated as a sliding direction.

The reception unit 41 receives the selection of the object of a movable part from the hardware model. Furthermore, the reception unit 41 receives the designation of an extraction range for each part assembly stored in the design data 30.

The control-software developer operates the input unit 20 to select the object of a movable part. Furthermore, the control-software developer operates the input unit 20 to designate a part extraction range.

FIG. 14B is a diagram illustrating an example designation of a part extraction range. In the example of FIG. 14B, the part C2 is selected as a movable part. Furthermore, in FIG. 14B, assemblies stored in the design data 30 and parts registered with each of the assemblies are displayed in a tree structure. For example, the control-software developer operates the input unit 20 to designate an assembly as a part extraction range. When an assembly is designated, parts are extracted from among the parts registered with the designated assembly. In contrast, when no assembly is designated, parts are extracted from among the parts of all the assemblies. In the example of FIG. 14B, the assembly C including the part C1 and the part C2 is designated as an extraction range. In this case, parts are extracted from the parts registered with the assembly C.

The control-software developer operates the input unit 20 to perform a predetermined operation for instructing the start of an extraction. For example, the control-software developer selects an extraction start button 95 illustrated in FIG. 14B.

The extraction unit 43 sequentially extracts parts in contact relation from the selected movable part, among a plurality of parts constituting the hardware model.

FIGS. 14C and 14D are diagrams illustrating an example extraction of parts. In the example of FIG. 14C, parts in contact relation from the part C2 are sequentially extracted. The part C1, the length of which in the sliding direction of the part C2 is equal to or larger than a predetermined multiple of the length of the part C2 in the sliding direction, is regarded as a fixed part. Furthermore, in the example of FIG. 14D, parts C90 and C91, which have a shape covering the extracted group of parts, are regarded as fixed parts.

The display control unit 40 controls displaying an extraction result obtained by the extraction unit 43. For example, the display control unit 40 displays a model in which the objects of parts extracted by the extraction unit 43 are arranged in a three-dimensional virtual space.

FIG. 14E is a diagram illustrating an example extraction of parts. In the example of FIG. 14E, a model in which the objects of the extracted parts are arranged in a three-dimensional virtual space is displayed.

The reception unit 41 receives the selection of a movable part and a non-movable part.

FIG. 14F is a diagram illustrating example display screens. In the example of FIG. 14F, screens 110 and 111 are displayed in a multiwindow configuration. The screen 110 displays a hardware model C101 of the whole machine, except for extracted parts. The screen 111 displays a model C100 in which the objects of the extracted parts are arranged. Furthermore, the screen 111 has a designation region 112 and a designation region 113. The designation region 112 displays a designated non-movable part, and the designation region 113 displays a designated movable part. For example, when the control-software developer selects the object of a non-movable part from the model displayed on the screen 111, the designation region 112 displays the designated part in addition to the non-movable part.

When the model displayed on the screen 111 has a lacking part, the control-software developer designates the lacking part as a movable part from the hardware model on the screen 110. Furthermore, when the model displayed on the screen 111 have a spare part, the control-software developer designates the spare part as a non-movable part from the model C100 on the screen 111. In the example of FIG. 14F, the part C50 is selected as a movable part on the screen 110, and a part C10 is selected as a non-movable part on the screen 111. The screen 111 has a re-extraction button 120 and an OK button 121. When the re-extraction button 120 is selected, the extraction unit 43 re-extracts parts in contact relation. For example, the extraction unit 43 re-extracts parts in contact relation from the added movable part and the designated movable part. Furthermore, the extraction unit 43 targets parts other than the added non-movable part and the designated non-movable part to extract parts in contact relation.

The display control unit 40 displays a model in which the objects of the parts extracted by the extraction unit 43 are arranged.

FIG. 14G is a diagram illustrating an example re-extraction result. In the example of FIG. 14G, the part C10 designated as a non-movable part is displayed on the screen 110, and the part C50 added to the movable part and parts in contact relation with the part C50 are displayed on the screen 111.

When the OK button 121 is selected, the determination unit 44 regards the extracted parts as parts that move together with the movable parts to determine the parts constituting the movable joint part.

FIG. 14H is a diagram illustrating example parts constituting the joint part. In the example of FIG. 14H, the parts with a dotted pattern, including the part C2 and the part C50, are determined as the parts constituting the joint part 1.

The determination unit 44 stores the movable parts and the extracted parts in the joint part information 31 in association with each other.

This enables the support apparatus 10 according to the present embodiment to reduce time and labor in designating the movable parts constituting the joint part.

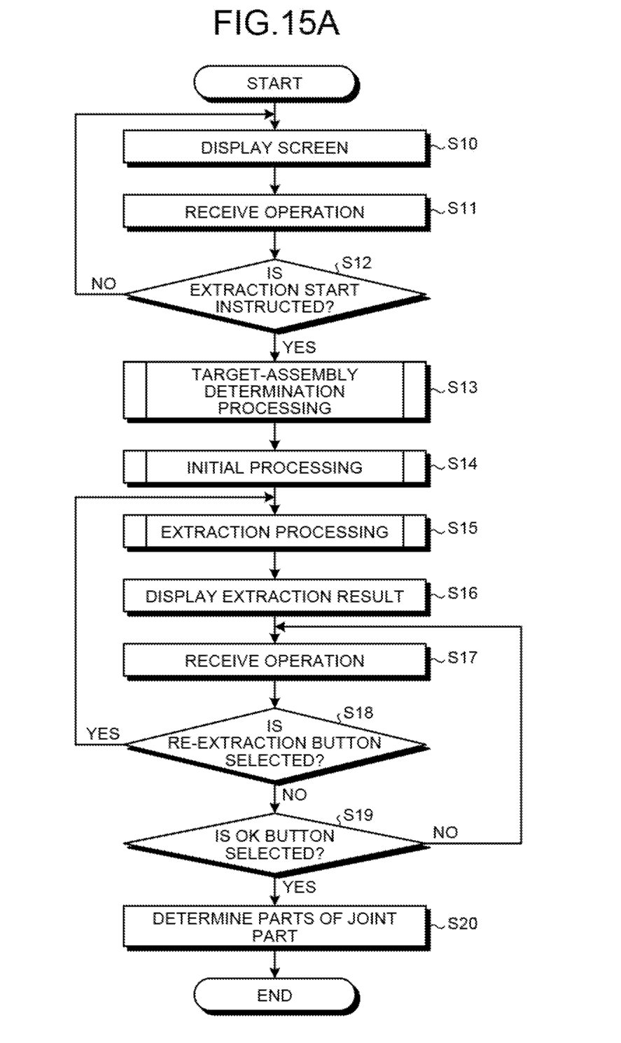

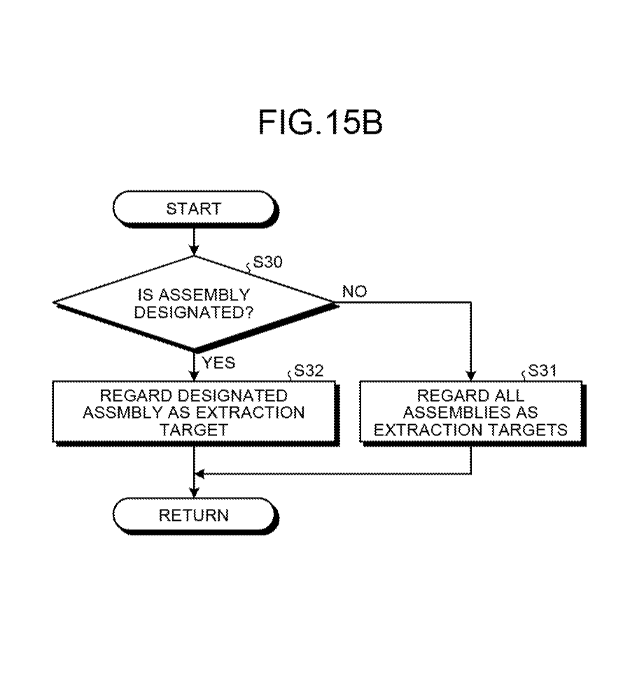

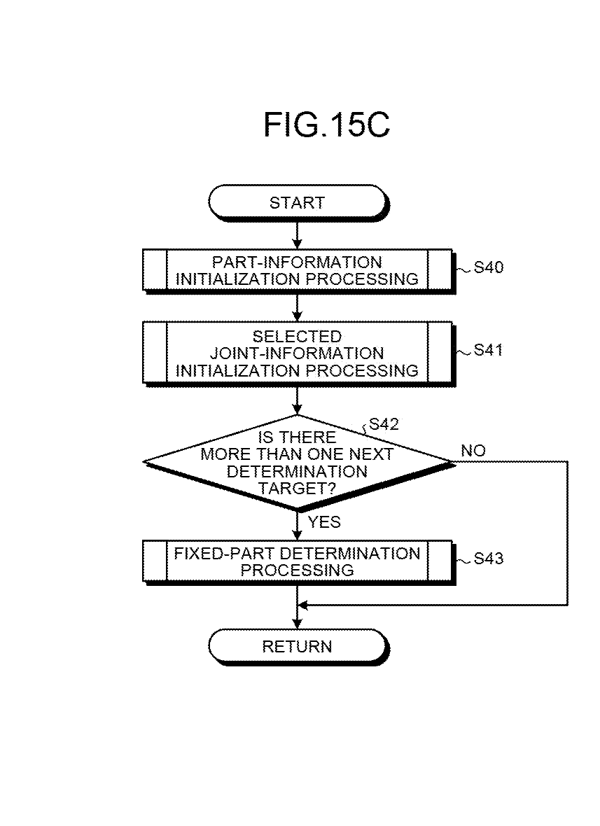

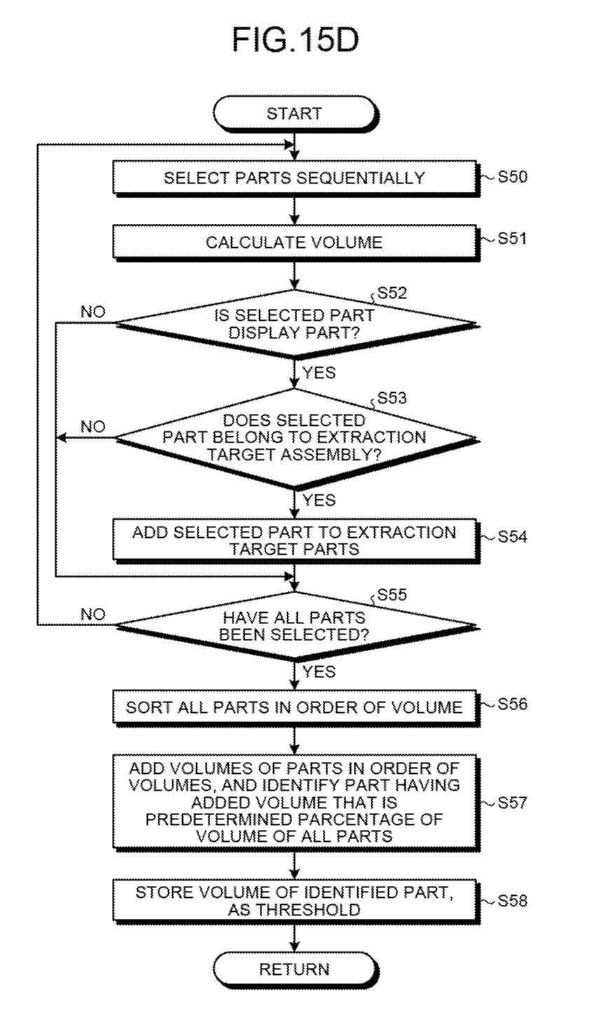

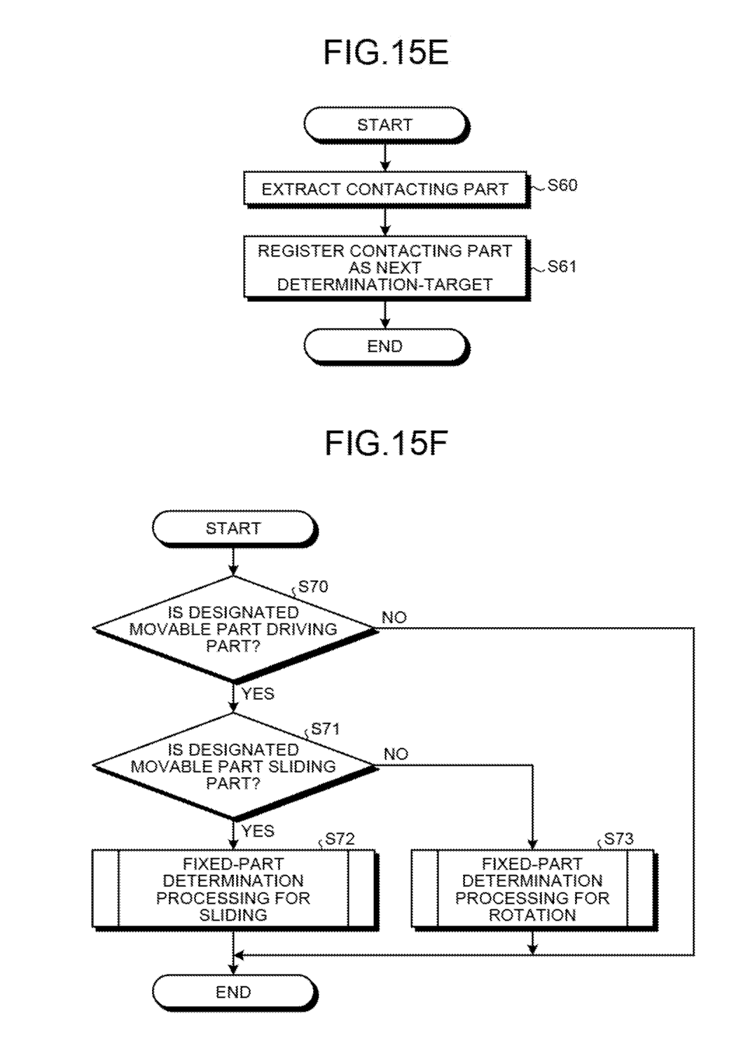

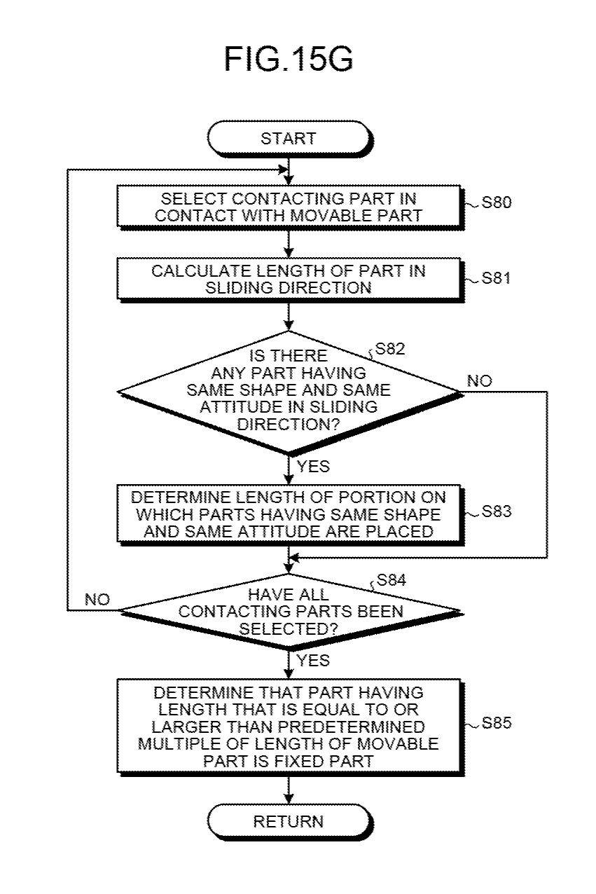

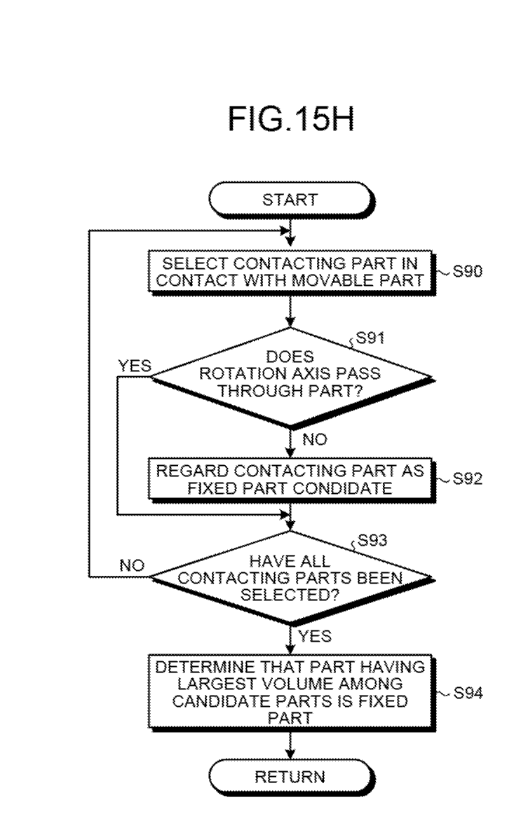

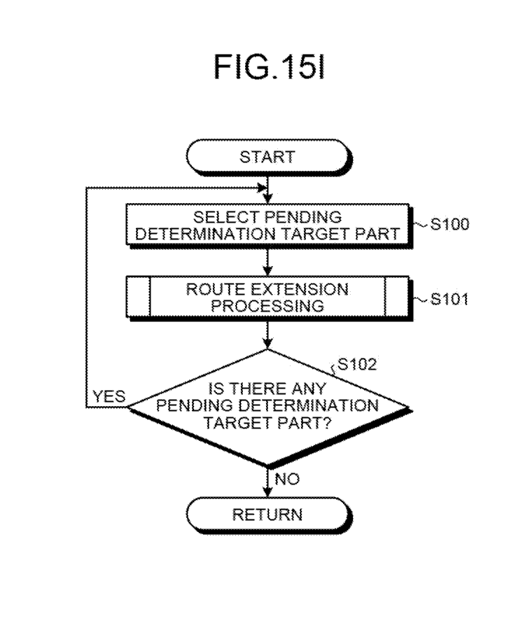

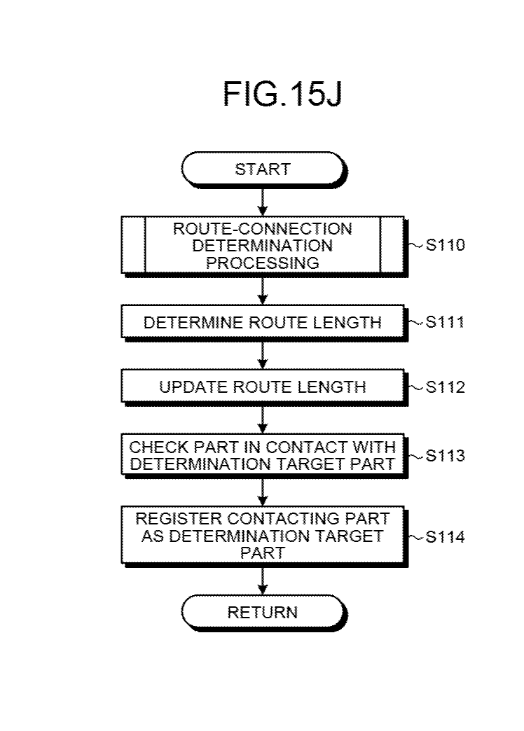

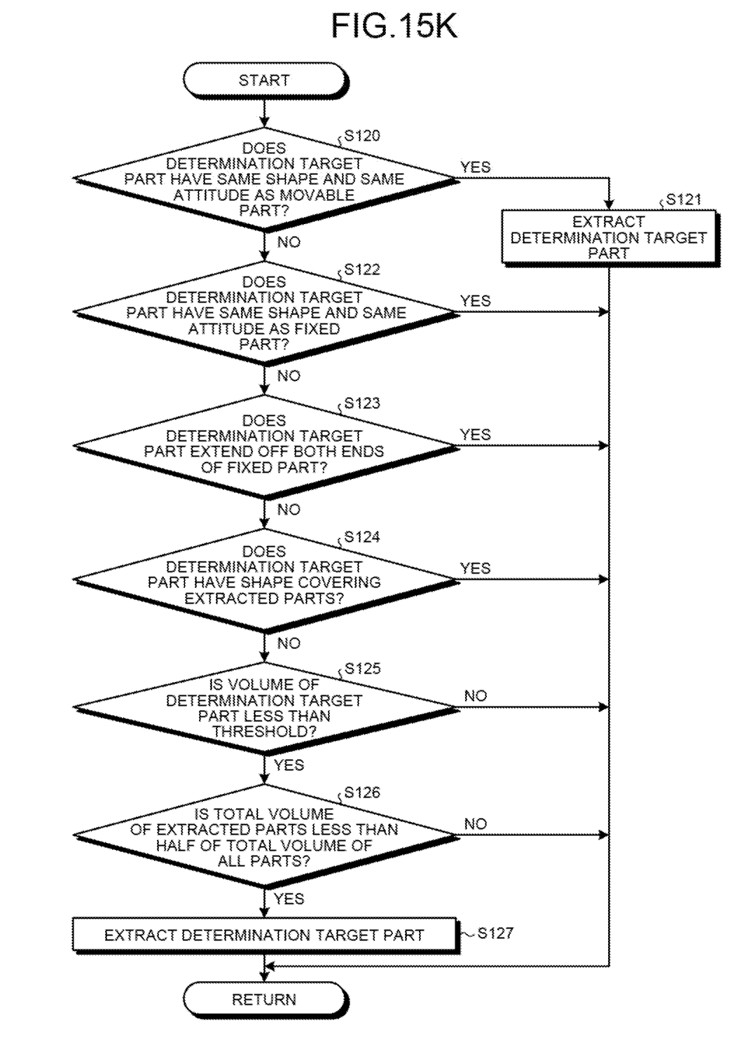

The flow of the support processing will now be described, where the support apparatus 10 according to the present embodiment supports the designation of movable parts. FIG. 15A is a flowchart illustrating an example process of the support processing.

As illustrated in FIG. 15A, the display control unit 40 controls displaying various types of information on the display unit 21 (S10). For example, as illustrated in FIG. 14B, the display control unit 40 displays a virtual hardware model in which the objects of parts are arranged in a virtual space, based on the design data 30. Furthermore, the display control unit 40 displays an assembly configuration of parts, based on the design data 30.

The reception unit 41 receives various types of designation via the input unit 20 (S11). For example, the reception unit 41 receives operations, such as zooming in or out of the displayed hardware model and a change of the display position of the hardware model. Furthermore, the reception unit 41 receives the selection of the object of a movable part from the hardware model. Furthermore, the reception unit 41 receives the designation of an extraction range for each part assembly stored in the design data 30.

The control-software developer operates the input unit 20 to select the object of a movable part. Furthermore, the control-software developer operates the input unit 20 to designate a part extraction range. For example, the control-software developer operates the input unit 20 to designate an assembly as a part extraction range. At the start of extracting movable parts, the control-software developer performs a predetermined operation to instruct the start of the extraction.

The extraction unit 43 determines whether the predetermined operation to instruct the start of the extraction is performed (S12). If the predetermined operation is not performed (No at S12), the process moves to S10 described above. In contrast, if the predetermined operation is performed (Yes at S12), the extraction unit 43 performs target-assembly determination processing that determines an extraction target assembly (S13).

FIG. 15B is a flowchart illustrating an example process of the target-assembly determination processing. The target-assembly determination processing begins at, for example, S13 in FIG. 15A.

As illustrated in FIG. 15B, the extraction unit 43 determines whether an assembly in an extraction range is designated (S30). If no assembly is designated (No at S30), the extraction unit 43 regards all the assemblies as assemblies to be extracted (S31).

In contrast, if any assembly is designated (Yes at S30), the extraction unit 43 regards the designated assembly as an extraction target assembly (S32). After the completion of the processing in S31 and S32, the process moves to S14 in FIG. 15A.

Returning to FIG. 15A, the extraction unit 43 performs initial processing (S14).

FIG. 15C is a flowchart illustrating an example process of the initial processing. The initial processing begins at, for example, S14 in FIG. 15A.

As illustrated in FIG. 15C, the extraction unit 43 performs part-information initialization processing that initializes part information (S40).

FIG. 15D is a flowchart illustrating an example process of the part-information initialization processing. The part-information initialization processing begins at, for example, S40 in FIG. 15C.

As illustrated in FIG. 15D, the extraction unit 43 sequentially selects parts stored in the design data 30 (S50). The extraction unit 43 calculates the volume of the selected part, based on the design data 30 (S51). The extraction unit 43 determines whether the display of the selected part is designated (S52). If the display is not designated (No at S52), the process moves to S55 described below.

In contrast, if the display is designated (Yes at S52), it is determined whether the selected part belongs to any extraction target assembly (S53). If the selected part does not belong to any extraction target assembly (No at S53), the process moves to S55 described below.

In contrast, if the selected part belongs to any extraction target assembly (Yes at S53), the extraction unit 43 adds the selected part to extraction target parts (S54).

The extraction unit 43 determines whether the selection of all the parts stored in the design data 30 has been completed (S55). If the selection of all the parts has not been completed (No at S55), the process moves to S50 described above.

In contrast, if the selection of all the parts has been completed (Yes at S55), the extraction unit 43 sorts all the parts stored in the design data 30 in the descending order of their volumes (S56). The extraction unit 43 adds the volumes of the parts in the descending order of their volumes, and identifies a part having an added volume that is a predetermined percentage of the volume of all the parts (S57). The extraction unit 43 stores the volume of the identified part, as a threshold of a fixed part (S58). After the completion of the processing in S53, the process moves to S41 in FIG. 15C.

Returning to FIG. 15C, the extraction unit 43 performs selected-joint-information initialization processing (S41).

FIG. 15E is a flowchart illustrating an example process of the selected-joint-information initialization processing. The selected-joint-information initialization processing begins at, for example, S41 in FIG. 15C.

As illustrated in FIG. 15E, the extraction unit 43 extracts a part in contact with the selected movable part from among the extraction target parts (S60). For example, the extraction unit 43 regards the selected movable part as a determination target part and based on the design data 30, extracts a part in contact with the determination target part from among the extraction target parts. The extraction unit 43 registers the extracted part as a next-determination-target part (S61). After the completion of the processing in S61, the process moves to S42 in FIG. 15C.

Returning to FIG. 15C, the extraction unit 43 determines whether there is more than one next-determination-target part, which is registered in S61 (S42). If there is more than one next-determination-target part (Yes at S42), fixed-part determination processing that automatically determines a fixed part is performed (S43). After the completion of the processing in S43, if there is not more than one next-determination-target part (No at S42), the process moves to S15 in FIG. 15A.

FIG. 15F is a flowchart illustrating an example process of the fixed-part determination processing. The fixed-part determination processing begins at, for example, S43 in FIG. 15C.

As illustrated in FIG. 15F, the extraction unit 43 determines whether the selected movable part is a driving part (S70). If the movable part is a driving part (Yes at S70), the extraction unit 43 determines whether the selected movable part is a sliding driving part (S71). If the movable part is a sliding driving part (Yes at S71), fixed-part determination processing for sliding is performed (S72). In contrast, if the movable part is not a sliding driving part (No at S71), fixed-part determination processing for rotation is performed (S73). After the completion of the processing in S72 and S73, if the selected movable part is not a driving part (No at S70), the process moves to S15 in FIG. 15A.

FIG. 15G is a flowchart illustrating an example process of the fixed-part determination processing for sliding. The fixed-part determination processing for sliding begins at, for example, S72 in FIG. 15F.

As illustrated in FIG. 15G, the extraction unit 43 selects a contacting part in contact with the selected movable part from among the extraction target parts (S80). The extraction unit 43 calculates the length of the selected contacting part in the sliding direction of the movable part (S81). The identification unit 42 determines whether there is any part having the same shape and the same attitude as the selected contacting part in the sliding direction (S82). If there is no part having the same shape and the same attitude (No at S82), the process moves to S84 described below.

In contrast, if there is any part having the same shape and the same attitude (Yes at S82), the extraction unit 43 determines the length, in the sliding direction, of the portion on which the contacting part and parts having the same shape and the same attitude as the contacting part are placed (S83). That is, the extraction unit 43 determines the length, in the sliding direction, of the contacting part and the parts having the same shape and the same attitude as the contacting part, including portions between the contacting part and the parts having the same shape and the same attitude as the contacting part.

The extraction unit 43 determines whether all the contacting parts have been selected (S84). If not all the contacting parts have been selected (No at S84), the process moves to S80 described above.

In contrast, if all the contacting parts have been selected (Yes at S84), the extraction unit 43 determines that a part having a length in the sliding direction that is equal to or larger than a predetermined multiple of the length of the selected movable part in the sliding direction is a fixed part (S85), and the process moves to S15 in FIG. 15A.

FIG. 15H is a flowchart illustrating an example process of the fixed-part determination processing for rotation. The fixed-part determination processing for rotation begins at, for example, S73 in FIG. 15F.

As illustrated in FIG. 15H, the extraction unit 43 selects a contacting part in contact with the selected movable part, from among the extraction target parts (S90). The extraction unit 43 determines whether the rotation axis of the movable part passes through the selected contacting part (S91). If the rotation axis of the movable part passes through the selected contacting part (Yes at S91), the process moves to S93 described below.

In contrast, if the rotation axis of the movable part does not pass through the selected contacting part (No at S91), the extraction unit 43 regards the selected contacting part as a fixed part candidate (S92).

The extraction unit 43 determines whether all the contacting parts have been selected (S93). If not all the contacting parts have been selected (No at S93), the process moves to S90 described above.

In contrast, if all the contacting parts have been selected (Yes at S93), the extraction unit 43 determines that the contacting part having the largest volume among the fixed part candidates is a fixed part (S94), and the process moves to S15 in FIG. 15A.

Returning to FIG. 15A, the extraction unit 43 performs extraction processing that extracts parts in contact relation (S15).

FIG. 15I is a flowchart illustrating an example process of the extraction processing. The extraction processing begins at, for example, S15 in FIG. 15A.

As illustrated in FIG. 15I, the extraction unit 43 selects a pending determination target part (S100). The extraction unit 43 performs route extension processing that determines whether the selected determination target part constitutes a joint part (S101).

FIG. 15J is a flowchart illustrating an example process of the route extension processing. The route extension processing begins at, for example, S101 in FIG. 15I.

As illustrated in FIG. 15J, the extraction unit 43 performs route connection determination processing that determines whether the determination target part is connectable (S110).

FIG. 15K is a flowchart illustrating an example process of the route-connection determination processing. The route-connection determination processing begins at, for example, S110 in FIG. 15J.

As illustrated in FIG. 15K, the extraction unit 43 determines whether the determination target part has the same shape and the same attitude as the selected movable part (S120). If the determination target part has the same shape and the same attitude as the movable part (Yes at S120), the extraction unit 43 extracts the determination target part, as a part constituting the joint part (S121) and the process moves to S111 in FIG. 15J.

In contrast, if the determination target part does not have the same shape and the same attitude as the movable part, (No at S120), the extraction unit 43 determines whether the determination target part has the same shape and the same attitude as a fixed part (S122). If the determination target part has the same shape and the same attitude as a fixed part (Yes at S122), the process moves to S111 in FIG. 15J.

In contrast, if the determination target part does not have the same shape and the same attitude as a fixed part (No at S122), the extraction unit 43 determines whether the determination target part extends off both ends of the fixed part (S123). If the determination target part extends off both ends of the fixed part (Yes at S123), the process moves to S111 in FIG. 15J.

In contrast, if the determination target part does not extend off both ends of the fixed part (No at S123), the extraction unit 43 determines whether the determination target part has a shape covering the extracted parts (S124). If the determination target part has a shape covering the extracted parts (Yes at S124), the process moves to S111 in FIG. 15J.

In contrast, if the determination target part does not have a shape covering the extracted parts (No at S124), the extraction unit 43 determines whether the volume of the determination target part is less than a threshold of the fixed part (S125). If the volume is not less than the threshold of the fixed part (No at S125), the process moves to S111 in FIG. 15J.

In contrast, if the volume is less than the threshold of the fixed part (Yes at S125), the extraction unit 43 determines whether the total volume of the extracted parts is less than half of the total volume of all the parts (S126). If the total volume of the extracted parts is not less than half of the total volume of all the parts (No at S126), the process moves to S111 in FIG. 15J.

In contrast, if the total volume of the extracted parts is less than half of the total volume of all the parts (Yes at S126), the extraction unit 43 extracts, as a part constituting the joint part, the determination target part (S127) and the process moves to S111 in FIG. 15J.

Returning to FIG. 15J, the extraction unit 43 determines the shortest route length from the movable part, for each determination target part (S111). For example, the extraction unit 43 determines parts in contact relation with the movable part up to the determination target part and calculates the distance of the route connecting the location of the center of gravity of each part. The extraction unit 43 then regards the route having the shortest distance as the shortest route from the movable part and regards the distance of the route having the shortest distance as the shortest route length. For each determination target part, the extraction unit 43 updates the shortest route length and stores it (S112).

The extraction unit 43 identifies a part in contact with the determination target part, from among the extraction target parts (S113). For example, the extraction unit 43 identifies a part in contact with the determination target part, from among the extraction target parts, based on the design data 30. The extraction unit 43 registers the identified contacting part as a determination target part (S114), and the process moves to S112 in FIG. 15I.

Returning to FIG. 15I, the extraction unit 43 determines whether there is any pending determination target part (S102). If there is any pending determination target part (Yes at S102), the process moves to S100 described above.

If there is no determination target part (No at S102), the process moves to S16 in FIG. 15A.

Returning to FIG. 15A, the display control unit 40 controls displaying the extraction result on the display unit 21 (S16). For example, as illustrated in FIG. 14F, the display control unit 40 displays the screen 110 and the screen 111 in a multiwindow configuration. The screen 110 displays the hardware model C101 of the whole machine, except for the extracted parts, and the screen 111 displays the model C100, in which the objects of the extracted parts are arranged.

The reception unit 41 receives various types of designation via the input unit 20 (S17). For example, the reception unit 41 receives the designation of a lacking part as a movable part from the hard ware model C101 on the screen 110, and the designation of a spare part as a non-movable part from the model C100 on the screen 111.

The extraction unit 43 determines whether the re-extraction button 120 is selected (S18). If the re-extraction button 120 is selected (Yes at S18), the process moves to S15 described above and the extraction processing is performed again.

In contrast, if the re-extraction button 120 is not selected (No at S18), it is determined whether the OK button 121 is selected (S19). If the OK button 121 is not selected (No at S19), the process moves to S17 described above.

In contrast, if the OK button 121 is selected (Yes at S19), the determination unit 44 determines the parts constituting the joint part (S20). For example, the determination unit 44 regards the extracted parts as parts that move together with the movable parts to determine the parts constituting the movable joint part, and stores the movable parts and the extracted parts in the joint part information 31 in association with each other. Then, the determination unit 44 terminates the processing.

In this way, the support apparatus 10 receives the selection of the object of a first part from a combination of the objects of a plurality of parts. The support apparatus 10 extracts an object in contact with the selected object of the first part and an object in contact with the object, among the objects of the plurality of parts. The support apparatus 10 determines that the extracted objects of the parts are target objects that move together with the object of the first part. This enables the support apparatus 10 to reduce time and labor in designating movable parts.

In addition, the support apparatus 10 further receives the selection of the object of a second part from among objects in contact with the object of the first part. The support apparatus 10 targets objects other than the object of the second part to perform extraction. This enables the support apparatus 10 to extract contacting objects, except for the selected the objects of the second part.

Furthermore, the support apparatus 10 determines that among the objects the plurality of parts, an object having the same shape and the same attitude as the object of the first part is an object that moves in the same way as the object of the first part. This enables the support apparatus 10 to reduce time and labor in designating objects that move in the same way as the object of the first part with the same shape and the same attitude as the object of the first part.

Furthermore, the support apparatus 10 identifies an object having the same shape and the same attitude as the object of the second part, among the objects of the plurality of parts. The support apparatus 10 targets the objects other than the object of the second part and the identified object to perform the extraction. This enables the support apparatus 10 to reduce time and labor in designating the objects of the same fixed parts as the object of the second part, which have the same shape and the same attitude as the object of the second part.

Furthermore, the support apparatus 10 targets objects having lengths, in a driving direction toward which the object of the first part is driven, that are less than a predetermined multiple of the length of the object of the first part in the driving direction, to perform the extraction. This enables the support apparatus 10 to extract a joint part including the first part, except for a fixed part that supports the first part.

Furthermore, the support apparatus 10 identifies a plurality of third objects placed along the driving direction toward which the object of the first part is driven and having the same shape and the same attitude, among objects in contact relation from the object of the first part. If the length of the objects of a plurality of third parts in a placed condition in the driving direction is equal to or larger than a predetermined multiple of the length of the object of the first part in the driving direction, the support apparatus 10 targets objects other than the objects of the plurality of third parts to perform the extraction. This enables the support apparatus 10 to extract a joint part, except for parts, such as conveying rollers.

Furthermore, if the total volume of the object of the first part and the extracted objects is equal to or larger than a predetermined percentage of the total volume of the plurality of objects, the support apparatus 10 completes the extraction of objects. This enables the support apparatus 10 to prevent all the parts of the machine from being extracted.

Furthermore, the support apparatus 10 targets objects other than an object in contact with a base object to perform the extraction. This enables the support apparatus 10 to extract a joint part, except for the base object.

Furthermore, the support apparatus 10 regards the base object as an object having a volume that is equal to or larger than a predetermined threshold defined based on the total volume of the plurality of objects or an object having a shape covering a group of objects identified as target objects. This enables the support apparatus 10 to determine the base part.

[b] Second Embodiment

Although the embodiment according to the disclosed apparatus has been previously described, the disclosed technique may be implemented in various different forms other than the above embodiment. Another embodiment included in the present invention will be described below.

For example, in the above embodiment, it has been described that by way of example, the extraction unit 43 determines the length of a part in direct contact with the selected movable part in the sliding direction to determine a fixed part, but the disclosed apparatus is not limited to this configuration. For example, the extraction unit 43 may determine the lengths of sequentially extracted parts in contact relation in the sliding direction to extract a fixed part.

Furthermore, the components of the illustrated apparatuses are functional concepts, and not always physically configured as illustrated. That is, the specific condition of the integration and distribution of the apparatuses is not limited to the schematic representations, and a whole or a part thereof may be functionally or physically distributed and integrated in any unit, based on, for example, various types of loads and usage. For example, the processing units illustrated in FIG. 1, i.e., the display control unit 40, the reception unit 41, the identification unit 42, the extraction unit 43, and the determination unit 44 may be integrated or divided. Furthermore, a whole or any part of the processing functions performed by the processing units may be implemented in a CPU and a program analyzed and executed on the CPU, or may be implemented in hardware with wired logic.

Support Program

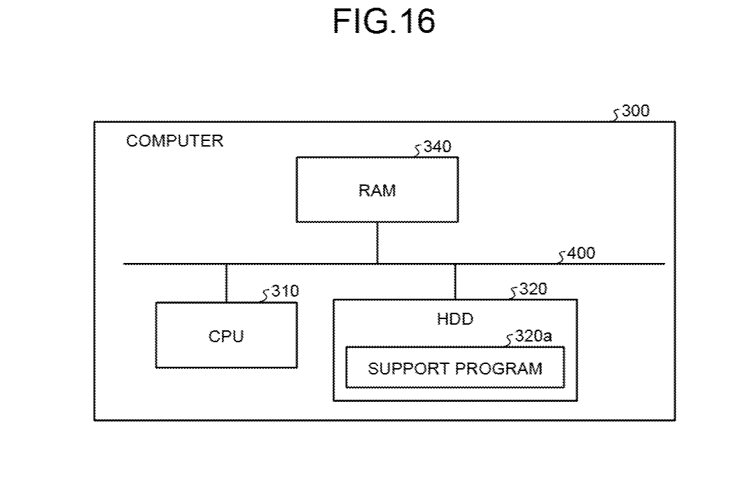

Furthermore, various types of processing described in the above embodiment can be also implemented by executing a previously prepared program on computer systems, such as personal computers and workstations. An example computer system that executes program having functions similar to the above embodiment will be described below. FIG. 16 illustrates a computer that executes a support program.

As illustrated in FIG. 16, a computer 300

includes a CPU 310, a hard disk drive (HDD) 320, and a random access memory (RAM) 340. These units 310 to 340 are each connected via a bus 400.

The HDD 320 previously stores a support program 320a that provides functions similar to the processing units in the above embodiment. For example, the support program 320a, which provides functions similar to the display control unit 40, the reception unit 41, the identification unit 42, the extraction unit 43, and the determination unit 44 in the above embodiment, is stored. The support program 320a may be divided.

Furthermore, the HDD 320 stores various types of data. For example, the HDD 320 stores an OS and various types of data.

Then, the CPU 310 reads out the support program 320a from the HDD 320 and executes it to perform operations similar to the processing units in the embodiment. That is, the support program 320a implements the operations similar to the display control unit 40, the reception unit 41, the identification unit 42, the extraction unit 43, and the determination unit 44 in the embodiment.

The support program 320a described above is not always initially stored in the HDD 320. The support program 320a may be stored in the HDD 320.

For example, the program is stored in a “portable physical medium” that is inserted into the computer 300, such as a flexible disk (FD), a compact disc read-only

memory (CD-ROM), a digital versatile disc (DVD), a magneto-optical disk, and an IC card. The computer 300 may then read out a program from such a medium to execute it.

Furthermore, the program is stored in, for example, “another computer (or server)” connected to the computer 300 via a public network, the Internet, a LAN, a WAN and other networks. The computer 300 may then read out a program from such a computer (or server) to execute it.

In one embodiment of the invention, there is provided the advantage of reducing time and labor in designating movable parts.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A computer-readable recording medium having stored therein a program that causes a computer to execute a process comprising:
receiving a selection of a first object from a combination of a plurality of objects;
extracting an object in contact with the first object and an object in contact with the object in contact with the first object, among the plurality of objects; and
determining that the extracted objects are target objects that move together with the first object.

2. The computer-readable recording medium according to claim 1, wherein
the receiving further receives a selection of a second object from among objects in contact with the first object, and
the extracting extracts the object in contact with the first object and the object in contact with the object in contact with the first object, from among objects other than the second object.

3. The computer-readable recording medium according to claim 1, wherein the determining determines that an object having a same shape and a same attitude as the first object is an object that moves in a same way as the first object, among the plurality of objects.

4. The computer-readable recording medium according to claim 2, wherein
the program further causes the computer to perform identifying an object having a same shape and a same attitude as the second object, among the plurality of objects, and
the extracting extracts the object in contact with the first object and the object in contact with the object in contact with the first object, from among objects other than the second object and the identified object.

5. The computer-readable recording medium according to claim 1, wherein the extracting extracts the object in contact with the first object and the object in contact with the object in contact with the first object, from among objects having a length, in a driving direction toward which the first object is driven, that is less than a predetermined multiple of a length of the first object in the driving direction.

6. The computer-readable recording medium according to claim 1, wherein
the program further causes the computer to execute identifying a plurality of third objects placed along a driving direction toward which the first object is driven and having a same shape and a same attitude, among objects in contact relation with the first object, and
when a length of the plurality of third objects in a placed condition in the driving direction is equal to or larger than a predetermined multiple of a length of the first object in the driving direction, the extracting extracts the object in contact with the first object and the object in contact with the object in contact with the first object, from among objects other than the plurality of third objects.

7. The computer-readable recording medium according to claim 1, wherein when a total volume of the first object and the extracted objects is equal to or larger than a predetermined percentage of a total volume of the plurality of objects, the extracting terminates the extracting of objects.

8. The computer-readable recording medium according to claim 1, wherein the extracting extracts the object in contact with the first object and the object in contact with the object in contact with the first object, from among objects other than an object in contact with a base object.

9. The computer-readable recording medium according to claim 6, wherein the base object is an object having a volume that is equal to or larger than a predetermined threshold defined based on a total volume of the plurality of objects or an object having a shape covering a group of objects identified as target objects.

10. A support method by which a computer executes a process comprising:
receiving a selection of a first object from a combination of a plurality of objects;
extracting an object in contact with the first object and an object in contact with the object in contact with the first object, among the plurality of objects; and
determining that the extracted objects are target objects that move together with the first object.

11. A support apparatus comprising:
a memory; and
a processor coupled to the memory, the processor performs a process to:
receive a selection of a first object from a combination of a plurality of objects;
extract an object in contact with the first object and an object in contact with the object in contact with the first object, among the plurality of objects; and
determine that the extracted objects are target objects that move together with the first object.
